(19) United States
(12) Patent Application Publication
(10) Pub. No.: US 2013/0181896 A1
(43) Pub. Date: Jul. 18, 2013

(54) INTEGRATED LIGHT EMITTING AND LIGHT DETECTING DEVICE

(71) Applicant: QUALCOMM MEMS Technologies, Inc., San Diego, CA (US)

(72) Inventors: Russell W. Gruhlke, Milpitas, CA (US); Jonathan C. Griffiths, Fremont, CA (US); John M. Wyrwas, Berkeley, CA (US); Ying Zhou, San Jose, CA (US); Xiquan Cui, San Jose, CA (US); Chung-Po Huang, San Jose, CA (US); Ron L. Feldman, Cupertino, CA (US); Jacek Maitan, Mountain View, CA (US); Khurshid S. Alam, Mountain View, CA (US); James C. Meador, Berkeley, CA (US)

(73) Assignee: QUALCOMM MEMS TECHNOLOGIES, INC., San Diego, CA (US)

(21) Appl. No.: 13/787,448

(22) Filed: Mar. 6, 2013

Related U.S. Application Data
(63) Continuation-in-part of application No. 13/411,381, filed on Mar. 2, 2012.
Application No. 13/411,381 is a continuation of application No. 12/559,085, filed on Sep. 14, 2009, now Pat. No. 8,138,479.
(60) Provisional application No. 61/147,044, filed on Jan. 23, 2009.

(51) Int. Cl. G06F 3/01

(52) U.S. Cl. CPC G06F 3/017
USPC 345/156

(57) ABSTRACT

Methods and systems for providing a light device that can emit light and sense light are disclosed. In one embodiment, a lighting device includes a light guide having a planar first surface, the light guide configured such that at least some ambient light enters the light guide through the first surface and propagates therein, and at least one light detector disposed along an edge of the light guide, the at least one detector optically coupled to the light guide to receive light propagating therein. The light detector can be configured to produce a control signal. In some embodiments, the lighting device also includes at least one light turning feature disposed on the first surface, the at least one light turning feature configured to direct light incident into the light guide through the first surface.

### CROSS-REFERENCE TO RELATED APPLICATIONS

This application is a continuation-in-part of U.S. application Ser. No. 13/411,381, filed Mar. 02, 2012, titled “INTEGRATED LIGHT EMITTING AND LIGHT DETECTING DEVICE,” which is a continuation of U.S. application Ser. No. 12/559,085, filed Sep. 14, 2009, titled “INTEGRATED LIGHT EMITTING AND LIGHT DETECTING DEVICE,” which claims the benefit of U.S. Provisional Application No. 61/147,044 filed on Jan. 23, 2009, titled “INTEGRATED LIGHT EMITTING AND LIGHT DETECTING DEVICE.” Each of these applications is expressly incorporated by reference in its entirety.

### BACKGROUND

1. Field

This invention relates to the fields of lighting and sensing, and in particular to light panels configured to emit light and/or detect light.

2. Description of the Related Art

A variety of architectural lighting configurations are utilized to provide artificial illumination in a variety of indoor and/or outdoor locations. Such configurations can include fixed and portable architectural lighting. Various configurations employ technologies such as incandescent, fluorescent, and/or light emitting diode based light sources.

One configuration of architectural lighting can be referred to generally as panel lighting. A panel lighting may include, for example, incandescent or fluorescent lighting in a light box behind a plastic lenticular panel. Panel lighting can be configured as a generally planar lighting devices, having width and length dimensions significantly greater than a thickness dimension. Panel lighting can use LED's as a light source, thus allowing its use in applications not suitable for normal incandescent or fluorescent light sources, including thinner panel configurations. Accordingly, improvements to panel lighting could allow its use for additional lighting applications not suitable for normal light sources.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments,” one will understand how the features of this invention provide advantages over other lighting devices.

At least some embodiments are based at least partially on a recognition that there exists an unsatisfied need for novel configurations of architectural lighting that offer improvements. For example, some embodiments provide a light panel configured to emit light and to detect a variation of light incident on the light panel. In various implementations described herein, the variation of light incident on the light panel can be produced by hand gestures. In such implementations, the detected variation of light incident on the panel can be analyzed and used for gesture recognition. Light panels having gesture recognition capability can be integrated with display devices to provide a new user interface (UI) which can advantageously extend two dimensional touch technology to three dimensions where hand gestures produced above the display can be used to control the display or other systems associated with the display. Some embodiments include a plurality of light turning features that direct light in one or more selected directions into or out of a light panel. Light received by a light panel may be guided within the light guide to one or more detectors.

According to one embodiment, the invention comprises a lighting device having a first light guide having a planar first surface and a planar second surface, at least one light gathering feature disposed on the first surface and configured to couple light incident on the first surface of the first light guide into the first light guide, and at least one light detector disposed along an edge of the first light guide coupled to the first light guide to receive light propagating therein, the at least one light detector configured to produce a control signal. In one aspect, the at least one light gathering feature comprises at least one of a diffractive feature, a reflective feature, a refractive feature, and a holographic film. In another aspect, the at least one light detector further comprises an output terminal, and wherein the at least one light detector is configured to provide the control signal to the output terminal for providing to a device electrically connected to the output terminal.

In one embodiment, the lighting device includes at least one light source optically coupled to at least one edge of the first light guide and at least one light turning feature configured to direct light propagating in the first light guide out of the first light guide. In one aspect, the control signal is configured to control at least a portion of the output of the at least one light source. In another aspect, the at least one turning feature includes more than one turning feature disposed on the front surface and/or back surface. In one aspect, the at least one light detector is configured to sense IR radiation and/or visible light and the at least one light source is configured to emit IR radiation and/or visible light. The light source can be configured to emit light having a wavelength within a first range and the at least one light detector can be configured to detect light having a wavelength within a second range and the first and second ranges can overlap or not overlap. In yet another aspect, the at least one light turning feature comprises a dot, groove, diffractive grating, hologram, and/or prismatic feature. In one aspect, the at least one light detector comprises a photodiode.

In another aspect, the at least one light detector includes a first detector disposed on a first edge of the first light guide and a second detector disposed on a second edge of the first light guide. In one aspect, the first and second detectors are each configured to provide control signals based on the light they receive. In another aspect, the first and second detectors can be coupled to a sensing circuit configured to determine a signal indicating a variation of light incident on the light guide based on the control signals. In one aspect the first edge can be disposed opposite the second edge. In yet another aspect, the sensing circuit signal can be configured to provide an indication of a direction of variation of incident light across the light guide. In one aspect, the first and second detectors are configured to produce a signal indicative of an object moving across at least a portion of the first surface that affects the light incident on the first surface.

In another aspect, the lighting device also includes a second light guide disposed parallel to the first light guide and an isolation layer disposed between the first light guide and the second light guide. The isolation layer can be configured to prevent at least some light propagating in the first light guide from entering the second light guide and/or to prevent at least some light propagating in the second light guide from entering the first light guide. In one aspect, the isolation layer comprises a material having a refractive index lower than the refractive index of the first and second light guide. In one aspect, the isolation layer has a refractive index that is between about 1.4 and about 1.6, the first light guide has a refractive index that is between about 1.4 and about 1.6, and the second light guide has a refractive index that is between about 1.4 and about 1.6. The isolation layer can include a material with an index of refraction between about 1.4 and about 1.6. In one aspect, the at least one light gathering feature comprises a dot, groove, diffractive grating, hologram, and/or prismatic feature.

According to another embodiment, the invention comprises a lighting system including a first lighting device having a first light guide having a planar first surface and a planar second surface, at least one light gathering feature disposed on the first surface and configured to couple light incident on the first surface of the first light guide into the first light guide, at least one light detector disposed along an edge of the first light guide coupled to the first light guide to receive light propagating therein, at least one light source optically coupled to at least one edge of the first light guide, and at least one light turning feature configured to direct light propagating in the first light guide out of the first light guide. The lighting system can also include a second lighting device configured to provide a control signal to the at least one light detector, wherein the at least one light detector is configured to control the light output from the at least one light source. In one aspect, the control signal comprises light output from the second lighting device. In another aspect, the light output from the second lighting device is pulse width modulated.

According to another embodiment, the invention comprises a method of manufacturing a lighting device including providing a light guide having a planar first surface and a planar second surface, disposing a first light detector along one or more edges of the light guide, the first light detector coupled to the first light guide to receive light propagating therein, disposing a second light detector along one or more edges of the light guide, the first light detector coupled to the first light guide to receive light propagating therein, forming a sensing circuit electronically coupled to the first light detector and the second light detector, the sensing circuit configured to determine a signal indicating a variation of light incident on the light guide based on signals provided by the first and second detector, forming at least one light gathering feature on at least one of the first surface and the second surface, the at least one light gathering feature configured to direct light incident on the light guide into the light guide, forming at least one light turning feature on at least one of the first and second surface, the at least one light turning feature configured to direct light propagating within the light guide away from the light guide, and disposing at least one light source along one or more edges of the light guide.

According to yet another embodiment, the invention comprises a lighting device including means for guiding light, means for detecting light, the means for detecting light disposed along one or more edges of the means for guiding light, the means for detecting light configured to detect light propagating within the means for guiding light, the means for detecting light further configured to produce a control means, and means for gathering light disposed on the means for guiding light, the means for gathering light configured to couple light incident on the means for guiding light into the means for guiding light. In one aspect, the means for guiding light comprises a light guide having a planar first surface and a planar second surface. In another aspect, the means for detecting light comprises at least one light detector disposed along an edge of the means for guiding light and coupled to the means for guiding light to receive light propagating therein. In one aspect, the means for gathering light comprises one or more light gathering features. In yet another aspect, the lighting device also includes means for producing light, the means for producing light coupled to the means for guiding light, and means for turning light disposed on the means for guiding light, the means for guiding light configured to direct light propagating within the means for guiding light away from the means for guiding light. In one aspect, the means for turning light comprises at least one light turning feature. In another aspect, the means for producing light comprises at least one light source.

According to one embodiment, the invention comprises a method of sensing movement of an object across a lighting panel based on the variation of light incident on the lighting panel, the lighting panel having at least two detectors coupled to the lighting panel, the method including at a first time, receiving light propagating within the lighting panel at the first detector and producing a first signal, the first signal indicating the amount of light detected by the first light detector at the first time, and receiving light propagating within the lighting panel at the second detector and producing a second signal, the second signal indicating the amount of light detected by the second detector at the first time, at a second time, receiving light propagating within the lighting panel at the first detector and producing a third signal, the third signal indicating the amount of light detected by the first light detector at the second time, and receiving light propagating within the lighting panel at the second detector and producing a fourth signal, the fourth signal indicating the amount of light detected by the second detector at the second time, and determining the direction of the movement of the object based on the first, second, third, and fourth signals. In one aspect, the method also includes emitting light from the light panel wherein receiving light propagating within the lighting panel at the first time and the second time comprises receiving ambient light that is incident on the lighting panel and light that was emitted from the light panel and reflected back toward the lighting panel.

Another innovative aspect of the subject matter described in this disclosure can be implemented in a device for receiving optical input. The device can include a reflective display, a light guide, a plurality of light detectors, and a processor. The light guide can be forward of the reflective display such that ambient light passes through the light guide to the reflective display. The light guide can include a plurality of turning features configured to receive a portion of the ambient light reflected from the reflective display and turn the portion of reflected light such that it is guided within the light guide. The plurality of light detectors can be disposed to receive the reflected light guided within the light guide. The processor can be configured to analyze one or more shadows cast on the device based on electrical signals from the plurality of light detectors.

In some implementations of the device, the reflective display can include a plurality of interferometric modulators, at least one electromechanical systems device, or at least one device having a movable actuator that modulates light. In some examples, between 20%-60% of the ambient light can be reflected by the device without being modulated.

In certain implementations, the light guide can have a forward surface configured to receive ambient light, a rearward surface configured to transmit the received ambient light toward the reflective display, and a plurality of edges enclosed between the forward and rearward surfaces. The plurality of optical sensors can be disposed along one or more of the plurality of edges. In some such implementations, the one or more shadows cast can be produced by hand gestures within less than about 4 inches from the forward surface of the light guide. Also, the plurality of turning features can be disposed on the forward surface of the light guide. In some examples, the plurality of turning features can include prismatic elements, reflective elements, scattering elements, and/or diffractive elements. A density of the plurality of turning features can be lesser near the plurality of edges of the light guide than a density of the plurality of turning features in a central portion of the light guide.

In various implementations, the device can further include a light source disposed along one or more of the plurality of edges. For example, the light source can include a plurality of light emitting diodes. Also, the plurality of light detectors can include at least one photodiode.

In some implementations, the device further can include a memory device that is configured to communicate with the processor. In addition, the device further can include a driver circuit configured to send at least one signal to the reflective display. In such implementations, a controller can be configured to send at least a portion of the image data to the driver circuit. The device further can include an image source module configured to send the image data to the processor. The image source module can include a receiver, transceiver, and/or a transmitter. The device also can include an input device configured to receive input data and to communicate the input data to the processor.

Another innovative aspect of the subject matter described in this disclosure can be implemented in a device for receiving optical input. The device can include a reflective display, a means for guiding light, a plurality of means for detecting light, and means for analyzing one or more shadows. The means for guiding light can be disposed forward of the reflective display such that ambient light passes through the light guiding means to the reflective display. The light guiding means can include a plurality of means for turning light configured to receive a portion of the ambient light reflected from the reflective display and turn the portion of reflected light such that it is guided within the light guiding means. The plurality of means for detecting light can be disposed to receive the reflected light guided within the light guiding means. The means for analyzing one or more shadows cast on the device can be based on electrical signals from the plurality of light detecting means.

In some such implementations, the light guiding means can include a light guide, the light turning means can include light turning features, the light detecting means can include photodiodes, or the analyzing means can include a processor. One or more of the shadows cast can be produced by hand gestures within less than about 4 inches from a forward surface of the light guiding means. The reflective display can include at least one display element having a movable actuator that modulates light.

Another innovative aspect of the subject matter described in this disclosure can be implemented in a method of optically recognizing gestures. The method can include reflecting a portion of ambient light that passes through a light guide from a surface of a reflective display on a device for receiving optical input. The light guide can be disposed forward of the reflective display. The method also can include turning the portion of reflected ambient light using a plurality of light turning features included in the light guide such that the portion of reflected ambient light is guided within the light guide towards a plurality of light detectors. Furthermore, the method can include analyzing one or more shadows cast on the device based on electrical signals from the plurality of light detectors. In some implementations of the method, one or more of the shadows cast can be produced by hand gestures within less than about 4 inches from a forward surface of the light guide.

### BRIEF DESCRIPTION OF THE DRAWINGS

FIG. 1 is a side view schematically illustrating one embodiment of a light panel configured to emit light.

FIG. 2 is an enlarged view of a portion of the light panel depicted in FIG. 1.

FIG. 3 is a side view schematically illustrating one embodiment of a light panel that may be coupled with a reflective display.

FIG. 4 is an enlarged view of a portion of the light panel depicted in FIG. 3 illustrating light turning features.

FIG. 5 is a side view of a light panel illustrating one embodiment configured to detect ambient light incident on one or more surfaces of the light panel.

FIG. 6A is a side view of a light panel illustrating one embodiment which is configured to detect light incident on a surface of the light panel where at least some of the incident light is provided by a light source.

FIG. 6B is a side view of an implementation of a light panel configured to detect gestures. The illustrated implementation includes a light guide having light redirectors and a plurality of light detectors disposed along the edges of the light guide.

FIG. 6C is a top view of an implementation of a light panel configured to detect gestures. The illustrated implementation includes a light guide having light redirectors, a plurality of light detectors disposed along two edges of the light guide, and a plurality of light emitters disposed along two other edges of the light guide.

FIG. 6D illustrates a flow chart of an example method of using the implementations of the light panel described herein for gesture recognition.

FIG. 7 is a top view schematically illustrating one embodiment of a light panel configured to detect variations in light incident on a surface of the light panel, including variations caused by moving an object (e.g., a hand) across a surface of the light panel.

FIG. 8 is a diagram schematically illustrating two photodiodes electrically connected in a configuration to provide a signal corresponding to the direction a sensed object moves across a surface of the light panel.

FIG. 9 is a diagram schematically illustrating signals based on the output of the two photodiodes depicted in FIG. 7 as a hand is moved across the light panel.

FIG. 10 is a side view schematically illustrating one embodiment of a panel configured to emit light across the panel and light an object proximate to the panel.

FIG. 11 is a side view schematically illustrating one embodiment of a panel configured to emit light and detect variations in light falling incident an object proximate to the panel.

FIG. 12 is a top view schematically illustrating one embodiment of a light panel.

FIG. 13 is a side view schematically illustrating the light panel depicted in FIG. 12.

FIG. 14 is a top view schematically illustrating one embodiment of a light panel.

FIG. 15 is a side view schematically illustrating the light panel depicted in FIG. 14.

FIG. 16 is a side view schematically illustrating an embodiment of a light panel configured to emit and detect light disposed near a reflector.

FIG. 17 is a side view schematically illustrating an embodiment of a light panel configured to emit and detect light.

FIG. 18 is a side view schematically illustrating an embodiment of a light panel configured to emit and detect light.

FIG. 19 is a side view schematically illustrating an embodiment of a light panel configured to emit and detect light having two light guides separated by a low refractive index layer.

FIG. 20 is a top view schematically illustrating an embodiment of a light panel configured to emit and detect light.

FIG. 21 is a top view schematically illustrating an embodiment of a light panel configured to emit and detect light.

FIG. 22 is a pulse width modulation diagram.

FIG. 23 is a pulse width modulation diagram.

FIG. 24 shows an example of an isometric view depicting two adjacent pixels in a series of pixels of an interferometric modulator (IMOD) display device.

FIG. 25 shows an example of a system block diagram illustrating an electronic device incorporating a 3×3 interferometric modulator display.

FIG. 26 shows an example of a diagram illustrating movable reflective layer position versus applied voltage for the interferometric modulator of FIG. 1.

FIG. 27 shows an example of a table illustrating various states of an interferometric modulator when various common and segment voltages are applied.

FIG. 28A shows an example of a diagram illustrating a frame of display data in the 3×3 interferometric modulator display of FIG. 2.

FIG. 28B shows an example of a timing diagram for common and segment signals that may be used to write the frame of display data illustrated in FIG. 5A.

FIG. 29A shows an example of a partial cross-section of the interferometric modulator display of FIG. 1.

FIGS. 29B-29E show examples of cross-sections of varying implementations of interferometric modulators.

FIG. 30 shows an example of a flow diagram illustrating a manufacturing process for an interferometric modulator.

FIGS. 31A-31E show examples of cross-sectional schematic illustrations of various stages in a method of making an interferometric modulator.

FIGS. 32A and 32B show examples of system block diagrams illustrating a display device that includes a plurality of interferometric modulators.

Like reference numbers and designations in the various drawings indicate like elements.

### DETAILED DESCRIPTION OF CERTAIN EMBODIMENTS

The following detailed description is directed to certain specific embodiments of the invention. However, the invention can be embodied in a multitude of different ways. For example, features included in a light emitting panel may also be included in a light sensing panel. As will be apparent from the following description, the innovative aspects may be implemented in any device that is configured for use in still and motion pictures. The innovative aspects may be implemented in any device including a light sensor that receives light from a source and detects changes in the intensity of the light from the source. The implementations described herein may be implemented in or associated with a variety of electronic devices such as, but not limited to, mobile telephones, multimedia Internet enabled cellular telephones, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers and/or navigators, cameras, camcorders, game consoles, wrist watches, electronic reading devices (e.g., e-readers), computer monitors, and a variety of electromechanical systems devices. Other uses are also possible. The teachings herein are not intended to be limited to the implementations depicted solely in the Figures, but instead have wide applicability as will be readily apparent to a person having ordinary skill in the art. In this description, reference is made to the drawings wherein like parts are designated with like numerals throughout.

In various embodiments described herein, a light source and/or light detector, or sensor, is coupled to a light guide to form a light panel. The light guide may comprise a plate, sheet or film with light turning features, for example, light extraction dots, grooves, diffractive gratings, holograms, or prismatic features disposed on one or more of its surfaces. Ambient light that is incident on the light guide may be gathered and turned into the light guide by the light turning features and guided through the light guide by total internal reflection. A light detector, for example, a photodiode, may be disposed along one or more edges of the light guide and may sense the ambient light gathered and guided into the light guide by the light turning features. In other embodiments, a light source, for example, one or more light emitting diodes (LEDs) may also be disposed along one or more edges of the light guide. The light emitted by the light source may be guided through the light guide by total internal reflection and extracted from the light guide by the light turning features. In some embodiments, the light detector may be configured to detect light that has entered the light guide. The detected light may be ambient light that has entered the light guide, and/or light emitted by the light source and extracted by the light turning features that is later reflected back into the light guide. In some embodiments, two differently configured sets of light turning features can be disposed on the light panel surfaces (e.g., intermingled). One set of light turning features can be configured to extract light from the panel, the other set to divert incident (ambient) light into the light panel.

Gesture recognition technology can be implemented in various electronic devices including a display (for example, e-readers, smart phones, tablet computers, desktop/laptop computers, smartphones, mobile phones, etc.) to extend a two-dimensional touch technology provided by touchscreens to three dimensions where hand gestures produced above the display can be used to control the display or other systems associated with the display. A possible implementation of gesture recognition technology includes emitting light from one or more sources of illumination (e.g. infrared light emitting diodes) that are disposed along the periphery of the display into the environment surrounding the display. The emitted light that is scattered by an object (e.g. hand, stylus, etc.) in the vicinity of the display is detected using one or more sensors (e.g. infrared detectors, cameras, etc.) that are also disposed around the periphery of the display to interpret the gesture. One possible disadvantage of such an implementation is that due to the limited field of view of the sensors, gestures that are produced in the far field of the display, such as, for example, in a region that is greater than about 4 inches above the display surface, are detected and interpreted more accurately than gestures that are produced in the near field of the display, such as, for example, in a region that is less than about 4 inches from the surface of the display.

Various implementations of the light panel including a light guide having light redirectors and light detectors disposed along the edges of the light guide as described herein can be integrated with display devices (e.g. reflective display devices) to enable gesture recognition in the near field (for example, at a distance of about 0.01 inches-4 inches). In one aspect, ambient light that is incident on the light panel is directed toward the display device. Ambient light directed toward the display can be used to illuminate the display device. Light that is reflected from the display device is redirected by the light redirectors and guided in the light guide toward the light detectors. Gestures produced by hand, fingers or other objects in the near field of the display device will obscure or intercept the ambient light and will cast a shadow on the display. The interception of the ambient light by hand, fingers or other objects producing the gesture would change (for example, reduce) the amount of light that is received by the light detectors and result in a variation in the electrical output of the light detectors. The variation in the electrical output of the light detectors can be indicative of a gesture event. The occurrence of a gesture event can be communicated to a processor included in the display device, for example, by using the variation in the electrical output of the light detectors to trigger the processor. The processor can interpret or recognize the gesture and send a control signal in accordance with the gesture to the display device or other devices associated with the display device. A wide variety of gestures can be recognized or interpreted by the processor including but not limited to hand swipes, hand blocking, scrolling, finger flexing, finger counting, wrist roll, two hand gestures, moving the hand or fingers along a direction normal to the display surface, etc.

Particular implementations of the subject matter described in this disclosure can be implemented to realize one or more of the following potential advantages. For example, near field gesture recognition systems can be more effective in controlling display devices having a smaller footprint, such as, for example, mobile devices, e-readers, tablet computers, etc. due to the limited field-of-view of such devices. Various implementations of the gesture recognition described herein can be used to detect the position of a hand, finger or stylus in the horizontal as well as the vertical direction, thus providing a three-dimensional user interface that can be integrated with various display devices. A three-dimensional user interface can be used to manipulate and/or interact with three-dimensional objects that are displayed. For example, gestures in which the hand, one or more fingers or a stylus moves in the vertical direction toward or away from the display device can be used to control the depth of a displayed three-dimensional image. As another example, gestures in which the wrist rolls while the hand is positioned over the display can be used to change the perspective of a displayed three-dimensional image. One advantage of the various implementations of gesture recognition systems disclosed herein is low power consumption due to the use of ambient light.

Turning now to FIG. 1, a light panel 101 is shown including a light guide 105 and a light source 109. The light panel 101 is configured to generate and emit light in one or more directions. The light guide 105 is configured to receive light generated and emitted by the light source 109, propagate the light within the light guide 105, and redirect the light such that at least a portion of the light 103 is emitted from the light panel 101 along the one or more selected emission directions. The light guide 105 can utilize the property of total internal reflection (“TIR”) and optical characteristics of light turning features that are disposed on a surface of the light guide 105 to direct and redirect light from the light source 109 through the light guide 105 and to emit light in the desired direction.

Still referring to FIG. 1, the light guide 105 may comprise optically transmissive material that is substantially optically transmissive to radiation at one or more wavelengths. For example, in one embodiment, the light guide 105 may be substantially optically transmissive to wavelengths in the visible and near infra-red region. In other embodiments, the light guide 105 may be transparent to certain wavelengths, for example, in the in the ultra-violet or infra-red regions.

The light guide 105 may comprise a substantially optically transmissive plate, sheet or film. The light guide 105 may be planar or curved. The light guide 105 may be formed from rigid or semi-rigid material such as glass or acrylic so as to provide structural stability to the embodiment. In other embodiments, the light guide 105 may be formed of flexible material such as a flexible polymer. Other materials for example, PMMA, polycarbonate, polyester, PET, cyclo-olefin polymer, or Zeonor may be used to form the light guide 105 in several other embodiments. In other embodiments, the light guide 105 may be formed of any material with an index of refraction greater than 1.0. The thickness may, in some embodiments, determine whether the light guide 105 is rigid or flexible. The optical transmissive properties, and the materials, of the light guide 105 can also be embodied on other light guides described herein.

Still referring to the embodiment shown in FIG. 1, the light guide 105 comprises two larger area surfaces and four smaller edge surfaces. In some embodiments, an upper surface 201a may be configured to emit light extracted by the light panel 101 or to receive ambient light. In some embodiments, a bottom surface 201b of the light guide may be connected to a substrate 107 and/or be configured to emit light extracted from the light guide 105. In various embodiments, the substrate 107 may be opaque, partially or substantially completely optically transmissive, or transparent. The substrate 107 may be rigid or flexible. The light guide 105 may be connected to the substrate 107 using a low refractive index adhesive layer (e.g., a pressure sensitive adhesive). Substrate 107 may comprise a diffuser. In certain embodiments, the substrate 107 may comprise a diffuser comprising an adhesive with particulates therein for scattering, for example, a pressure-sensitive adhesive with diffusing features. In some embodiments, the diffuser may also be formed using holographic recording techniques. The light guide 105 may be bounded by a plurality of edges all around. In some embodiments, the length and width of the light guide 105 is substantially greater than the thickness of the light guide 105. The thickness of the light guide 105 may be between 0.1 mm to 10 mm. The area of the light guide 105 may be between 1.0 cm² to 10,000 cm². However, dimensions outside these ranges are possible. In other embodiments, the light panel 101 may comprise a luminaire or a privacy screen.

Still referring to FIG. 1, the light guide 105 may be coupled with a light source 109. In some embodiments, the light guide 105 can be coupled with a light sensor (not shown). The light source 109 may be disposed along one or more edges of the light guide 105. The light source 109 may comprise any of a variety of light source technologies including fluorescent lamps, incandescent bulbs and/or LEDS. In some embodiments, the light source 109 may comprise one or more of a plurality of localized light sources, for example, one or more incandescent bulbs and/or LEDs and/or an array of LEDs. In some embodiments, an optional reflector 113 will be disposed near the light source 109 to direct the light emitted from the light source in one or more desired directions. It will be understood that depending on the particular implantation, an appropriate source of power will be included to provide operating power to the light source 109. Such power sources can include but are not limited to batteries, photovoltaic cells, fuel cells, generators, and/or an electrical power grid. It will also be understood that the light panel 101 will generally be provided with appropriate control circuitry which can include but need not require switches, voltage control circuitry, current control circuitry, ballast circuits, and the like. The power and control components of the light panel 101 are not illustrated for clarity and ease of understanding, however, appropriate power supply and control circuitry components will be understood by one of ordinary skill. As shown in the embodiment of FIG. 1, light 103 may propagate from the light source 109 through the light guide 105 and be directed from the light guide 105 towards one or more directions.

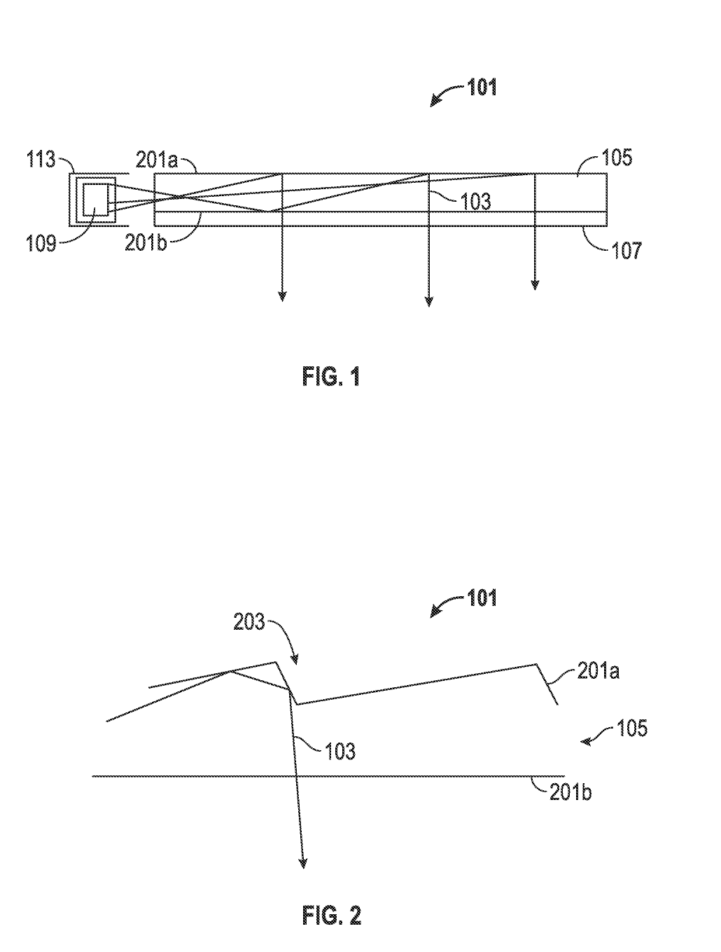

Turning now to FIG. 2, an enlarged side view of the light panel 101 shown in FIG. 1 depicts a portion of the upper surface 201a of the light guide 105 and the bottom surface 201b of the light guide 105. As shown in this embodiment, light 103 propagating through the light guide 105 may be trapped within the light guide 105 by total internal reflection until it encounters light turning features 203 formed in the upper surface 201a of the light guide 105. When the light 103 encounters a light turning feature 203, some of the light 103 may be extracted from the light guide 105 and turned towards the bottom surface 201b of the light guide 105. The light turning features 203 may comprise any feature configured to turn or extract light, for example, refractive features, dots, grooves, pits, prismatic features, holograms, or diffractive gratings. The light turning features 203 may be formed by a variety of techniques such as embossing or etching. Other techniques of forming the turning features may also be used. In some embodiments, the turning features 203 may be formed or disposed on a film that forms a part of the light guide 105 and is adhered to a surface of the light guide 105 (e.g., by lamination). In certain embodiments, the turning features 203 may also be disposed in or on the light guide 105. In one embodiment, the light turning features 203 comprise a plurality of elongate ridge or prism structures extending substantially across the upper surface 201a of the light guide 105. In another embodiment, a light guide 105 may comprise light turning features 203 on both sides and extract light from within the light guide in both directions. In one embodiment, the upper surface 201a comprises a plurality of microprisms extending along the width of the light guide 105. The microprisms may be configured to receive light propagating through the light guide 105 and turn light 103 through a large angle, for example, between about 70-90°.

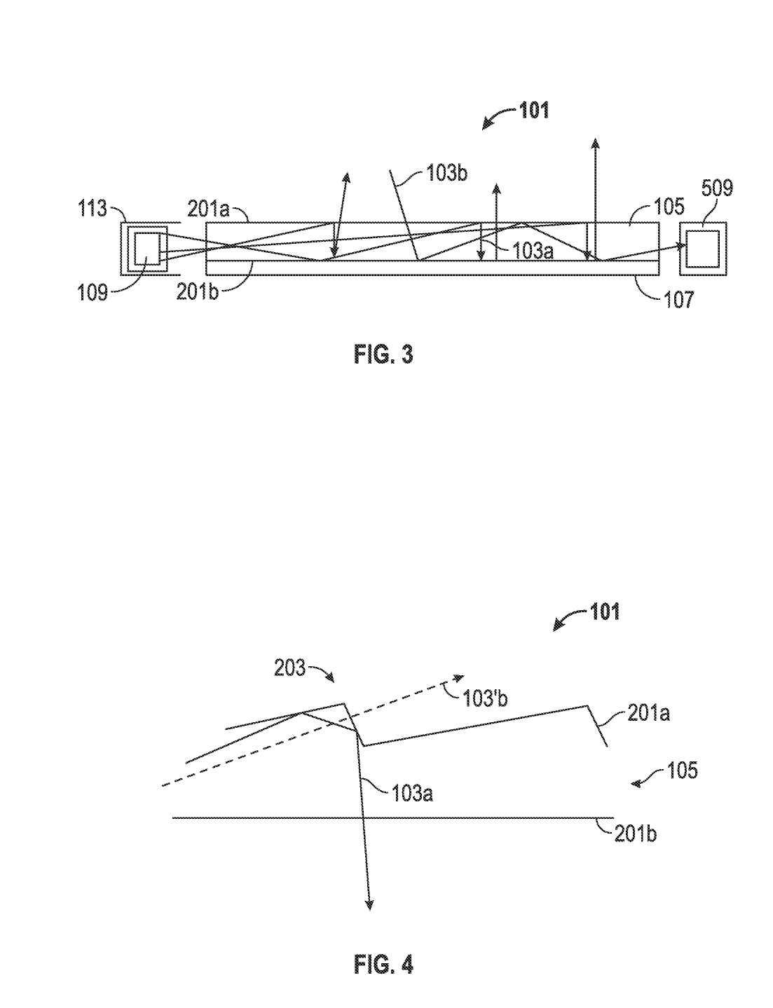

FIG. 3 is a side view schematically illustrating an embodiment of a light panel that may be coupled with a reflective display and FIG. 4 is an enlarged view of a portion of the light panel depicted in FIG. 3 illustrating light turning features 203. In the illustrated implementation, light rays 103a may be extracted from the light guide by light extracting features 203 on the light guide 105 and then reflected back through the light guide 105 by a reflective surface, for example, a reflecting surface of a reflective display device that is disposed rearward of the bottom surface 201b of the light guide 105. As shown in FIG. 4, some of the light 103′b propagating through the light guide 105 may “leak” through the upper surface 201a of the light guide 105 when incident at certain grazing angles while another portion of the light 103a propagating through the light guide 105 may be turned by light turning features 203 formed on the upper surface 201a. Thus, a portion of light 103a emitted by the light source may be directed out of one side of the light guide 105 while another portion of light 103b may be directed out of the other side of the light guide 105.

Referring to FIG. 3 again, the light panel 101 may also include one or more light detectors (or sensors) 509. In various embodiments, sensor 509 may be disposed along one or more edges of the light guide 105. The sensor 509 is configured to detect light 103 that travels within the light guide 105 to the light detector 509. The sensor 509 may detect light 103a that is input into the light guide 105 by the light source 109 and/or the sensor 509 may detect light 103b that is incident on the top surface of the light guide 105. Light 103b that is incident on the light guide 105 may be ambient light and/or light emitted by the light source 109 that is reflected back into the panel 101. The sensor 509 may be configured to sense, for example, visible light waves or infra-red waves. In one embodiment, the sensor 509 may comprise a photodiode.

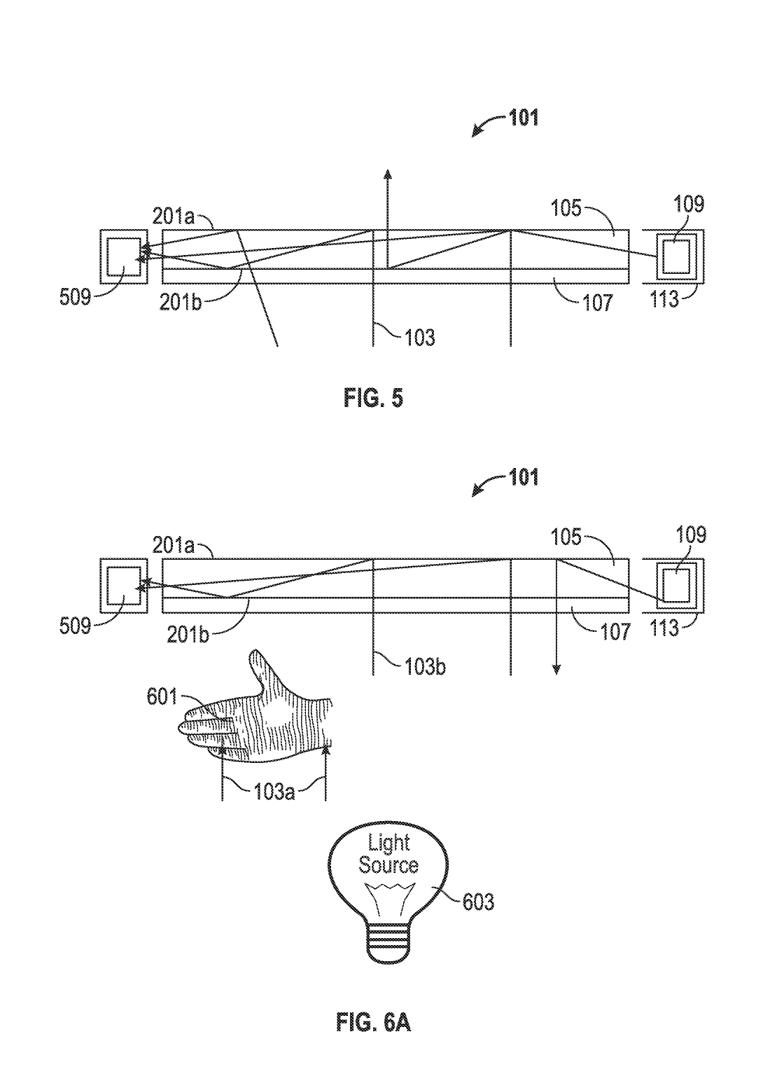

Turning now to FIG. 5, a light panel 101 configured to detect light is shown including a light guide 105 and at least one light detector (or sensor) 509. The light guide 105 may comprise optically transmissive material that is substantially optically transmissive to radiation at one or more wavelengths. The light guide 105 may comprise two surfaces. In some embodiments, one of the surfaces may be adhered to a substrate 107. The light guide 105 may include one or more light gathering features (not shown) configured to receive light incident on the light guide 105 and direct the light through the light guide 105. The light gathering features can turn the angle of incident rays of light inside the light guide 105 such that the ray of light 103 can be guided within the light guide 105 by total internal reflection. In some embodiments, the light gathering features may be embodied in a microstructured thin film. In some embodiments, light gathering features can be volume or surface diffractive features, or holograms disposed on one or more surfaces of the light guide 105.

The thickness of the light gathering features may range from approximately 1 μm to approximately 100 μm in some embodiments but may be larger or smaller. In some embodiments, the thickness of the light gathering features or layer may be between 5 μm and 50 μm. In some other embodiments, the thickness of the light gathering features or layer may be between 1 μm and 10 μm. The light turning gathering feature may be attached to surfaces of the light guide 105 by an adhesive. The adhesive may be index matched with the material comprising the light guide 105. In some embodiments, the adhesive may be index matched with the material comprising the light gathering feature. In certain other embodiments, light gathering features may be formed on the upper or lower surfaces of the light guide 105 by embossing, molding, or other process. Thus, the light guide 105 can be configured to receive light incident on one or more surfaces of the light guide from one or more directions, and direct the light through the light guide to the sensor 509.

Still referring to FIG. 5, the volume or surface diffractive elements or holograms can operate in transmission or reflection mode. The transmission diffractive elements or holograms generally comprise optically transmissive material and diffract light passing there through. Reflection diffractive elements and holograms generally comprise a reflective material and diffract light reflected therefrom. In certain embodiments, the volume or surface diffractive elements/holograms can be a hybrid of transmission and reflection structures. The diffractive elements/holograms may include rainbow holograms, computer-generated diffractive elements or holograms, or other types of holograms or diffractive optical elements. In some embodiments, reflection holograms may be preferred over transmission holograms because reflection holograms may be able to collect and guide white light better than transmission holograms. In those embodiments, where a certain degree of transparency is required, transmission holograms may be used. Transmissive layers may also be useful in embodiments that are designed to permit some light to pass through the light guide to spatial regions beneath the light guide. The diffractive elements or holograms may also reflect or transmit colors for design or aesthetic purpose. In embodiments, wherein the light guide is configured to transmit one or more colors for design or aesthetic purposes, transmission holograms or rainbow holograms may be used. In embodiments, wherein the light guide may be configured to reflect one or more colors for design or aesthetic purposes, reflection holograms or rainbow holograms may be used.

Still referring to FIG. 5, in some embodiments, the amount of light collected and guided by a light guide 105 can be referred to as the light collection efficiency of the light guide. Therefore, light turning features disposed on the light guide 105 can increase the light collection efficiency of the light guide 105. At least a portion of the light collected by the light guide 105 propagates to one or more sensors 509 disposed at one or more edges of the light guide. The sensors 509 may comprise detectors capable of sensing light waves, for example, visible light waves or infra-red waves. In one embodiment, the sensor 509 may comprise a photodiode capable of converting light into electrical energy (e.g., current or voltage) depending on the mode of operation of the photodiode. The electrical output from the sensor 509 can indicate a change in light falling onto the light guide 105, for example, from a change in ambient light conditions, or from an object positioned close enough to the light panel 101 to block ambient light from its surface. In some embodiments, the electrical output is a control signal used to trigger certain events, including to turn on or increase the light panel output due to low ambient light conditions, or to trigger another control event (for example, closing or opening a switch). In other embodiments, the sensor 509 can comprise control circuitry and the control circuitry can use the electrical output to create one or more control signals.

The embodiment illustrated in FIG. 5 also comprises a light source 109. Some embodiments do not include such a light source and instead sense only ambient light. The light source 109 may be disposed along one or more edges of the light guide 105 and may be configured to input light into the light guide 105. The light source 109 may comprise any of a variety of light source technologies including fluorescent lamps, incandescent bulbs and/or LEDS. In some embodiments, the light source 109 may comprise one or more of a plurality of localized light sources, for example, one or more incandescent bulbs and/or LEDs and/or an array of LEDs.

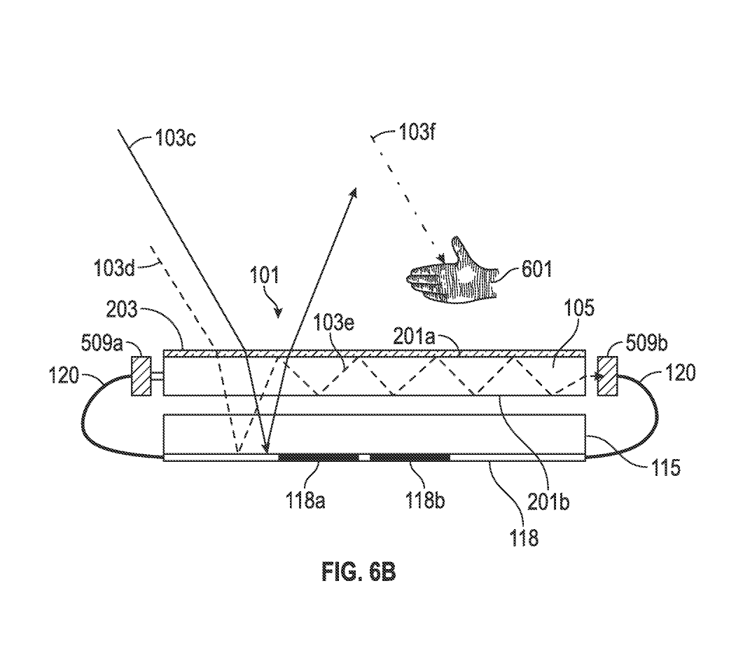

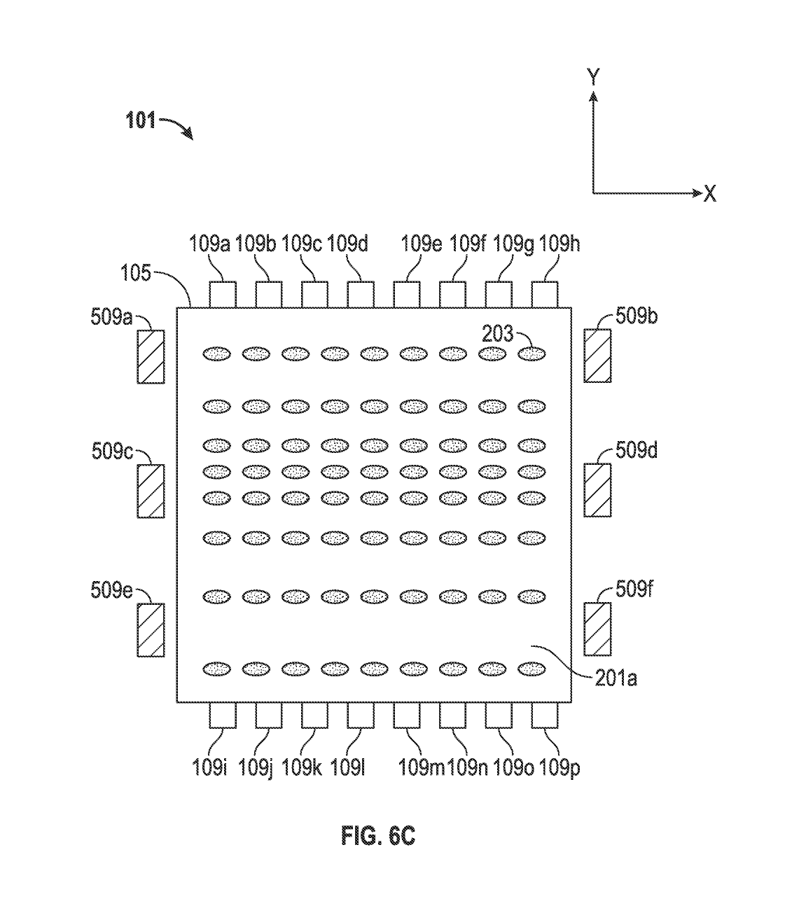

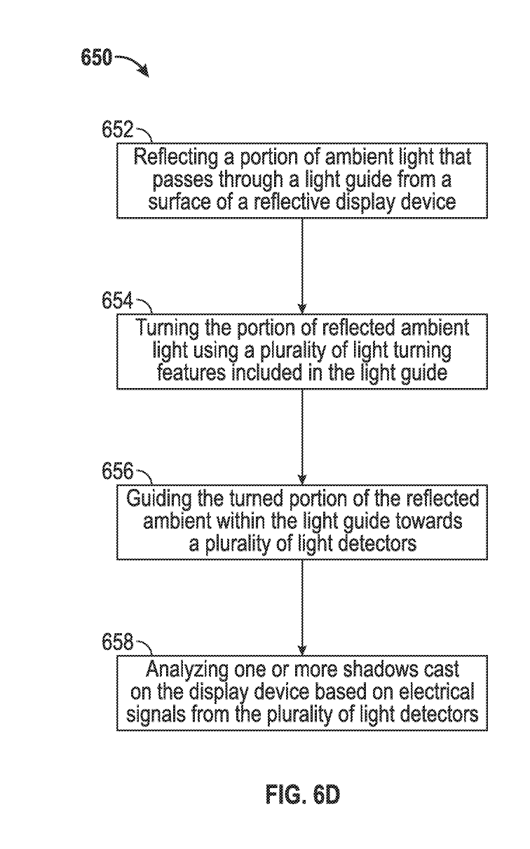

Turning now to FIG. 6A, the light panel 101 shown in FIG. 5 is depicted with an external light source 603 that may illuminate the light panel 101. Light emitted from the external light source 603 may be gathered by light gathering features (not shown) disposed on the surface of the panel 101 proximate to the light source 603 and propagate through the light guide 105 to one or more sensors 509. The external light source 603 may comprise ambient light or another source of light, for example, an incandescent light. A portion of the light emitted by the external light source 603 may be blocked by one or more objects 601 that lie between the external light source 603 and the light sensing light panel 101. For example, a hand, or similar object, may intercept light 103a emitted by the external light source 603 and prevent the sensor 509 from detecting the light 103a while another portion of light 103b emitted from the external light source 603 may be guided into the light guide 105 and detected by the sensor 509. In such embodiments, the light sensing light panel 101 may be used as a control for a light source to determine how much light should be emitted by the light source based on the amount of ambient light received by the sensor 509. In other embodiments, a light sensing light panel 101 may be used as a proximity sensor, a lighting fixture, or an occupancy sensor. For example, a light sensing panel 101 may be used to turn on, turn off, or dim a light emitting panel as the motion of an object, for example, a hand, across the light sensing panel 101 leads to specific electrical signatures. In one embodiment, the sensor 509 may be used to detect the amount of light incident on the light panel 101 and control the amount of light emitted by the light panel by the optional light source 109.

FIG. 6B is a side view of an implementation in which a light panel 101 is configured to detect gestures produced by an object 601. The illustrated implementation of the light panel 101 includes a light guide 105 having a forward surface 201a, a rearward surface 201b and including a plurality of edges between the forward surface 201a and the rearward surface 201b. A plurality of light redirectors 203 are disposed over the forward surface 201a and a plurality of light detectors 509a and 509b are disposed along the edges of the light guide 105.

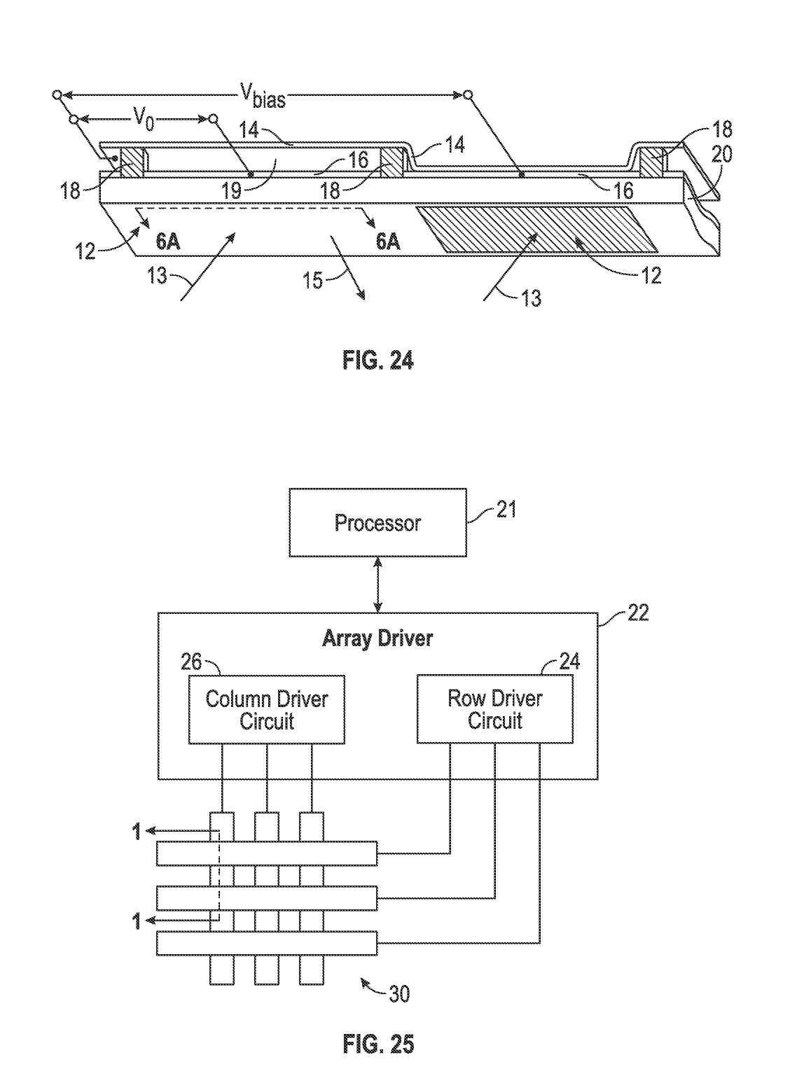

A display device 115 is disposed rearward of the light panel 101 such that the rearward surface 201b of the light guide 105 is adjacent the display device 115. In various implementations, the display device can be attached to the rearward surface 201b of the light guide 105. In some implementations, the display device 115 can be separated from the rearward surface 201b of the light guide 105 by a gap. In various implementations, one or more dielectric layers can be disposed between the rearward surface 201b of the light guide 105 and the display device 115. In various implementations, the display device 115 can be a reflective or a transflective display and include at least one partially reflecting surface. Examples of the display device 115 include but are not limited to liquid crystal based display devices, electro-mechanical systems devices, electrophoretic display devices, etc. In various implementations, the display device 115 can include a plurality of interferometric modulators (IMODs) which is an example of an electromechanical systems device and is described further below with reference to FIGS. 24-32B.

The display device 115 can include an electronic circuit 118 including one or more processors. In various implementations, the one or more processors in the electronic circuit 118 can be a gesture processor 118a and a display processor 118b. Although, the gesture processor 118a and the display processor 118b are illustrated as distinct processors on the implementation illustrated in FIG. 6B, in various implementations, the display processor 118b and the gesture processor 118a can be the same processor. In various implementations, the electronic circuit 118 can be a portion of the backplane of the display device 115 that includes driver electronics or thin film transistors (TFTs) that drive the active elements of the display device 115. The electronic circuit 118 can be electrically connected to the plurality of light detectors 509a and 509b by electrical conductive lines 120 that are configured to transport electrical signals generated by the plurality of light detectors 509a and 509b to the electronic circuit 118. In various implementations, the electrical conductive lines 120 can be flexible, such as, for example, flex cable, ribbon cables, etc. In various implementations, the electrical circuit 118 can be electrically connected to the plurality of light detectors 509a and 509b by interconnects.

The display device 115 includes active and inactive elements. The active elements of the display device 115 are configured to modulate a portion of incident light based on an input image data to display an image. The modulated light is directed toward a viewer such that the viewer can view the displayed image. For a reflective display device, a first portion of light incident on the display device 115 can be modulated by the active elements and reflected toward the viewer. Ray 103c is a representative of the portion of the incident light that is modulated by the display 115 and directed toward a viewer. Light incident on the display device 115 can also be reflected by the inactive elements without being modulated. For example, in various implementations of a reflective display device, about 20%-60% of the incident light can be reflected without being modulated. A portion of the light that is reflected from the display device 115 can be used for gesture recognition and to control the display device 115 as described below.

For the purpose of gesture recognition, the light that is reflected from the display device 115 is redirected by the plurality of light redirectors 203 and guided in the light guide 105 toward the plurality of light detectors 509a and 509b by multiple total internal reflections from the forward and rearward surfaces 201a and 201b of the light guide 105. Ray 103d is a representative of a portion of the incident light that is reflected by the display device and trapped in the light guide 105 as ray 103e. Gestures produced by hand, fingers, stylus or other objects in the near field of the display device 115 will obstruct the ambient light and will cast a shadow on the display. For example, in FIG. 6B, object 601 obstructs ray of light 103f from reaching the light panel 101 and is thus not acted upon by the display. The temporary interception of a portion of the ambient light by hand, fingers or other objects producing the gesture would reduce the amount of light that is received by the plurality of light detectors 509a and 509b and result in a change in the electrical output of the light detectors 509a and 509b. Thus, a change in the electrical output of the light detectors 509a and 509b can be indicative of a gesture event.

The electrical output from the plurality of light detectors 509a and 509b is communicated to the gesture processor 118a to detect and interpret a gesture. Since, the change in the electrical output from the two light detectors 509a and 509b can depend on the position, duration and the shape of the cast shadow, the spatio-temporal characteristic of the gesture can be obtained by analyzing the shadow or in other words the change in the electrical output of the light detectors 509a and 509b. For example, a gesture produced at a position that is closer to the light detector 509a can result in a greater change in the amount of light received by light detector 509a as compared to a change in the amount of light received by light detector 509b. Accordingly, if the gesture processor recognizes that the change in the electrical output of the light detector 509a is greater than the change in the electrical output of the light detector 509b, then it can interpret the gesture to have occurred spatially closer to the light detector 509a than the light detector 509b. In such a manner, the gesture processor can determine the position, duration and shape of the cast shadow (and consequently recognize gestures produced) in the near field and far field of the display. In various implementations, the detection of shadows by the plurality of light detectors 509a and 509b can be more effective in the near field of the display device 115. In various implementations, shadow cast by objects at a distance of approximately 0.01-4 inches from the forward surface 201a of the light guide 105 can be detected and their motion sensed more effectively than shadow cast by objects that are farther from the forward surface 201 a of the light guide 105.

The gesture processor 118a is configured to analyze and recognize gestures produced in close proximity (for example, at a distance of about 4 inches or less) of the forward surface 201a of the light panel 101. In order to recognize gestures, the gesture processor 118a is configured to process electronic signals related to changes in the intensity of light received by the plurality of light detectors 509a and 509b resulting from the shadow produced by the gestures in close proximity to the light panel 101. Processing of the electronic signals can include, executing instructions based on various gesture algorithms by the gesture processor 118a. Based on the gesture, the gesture processor 118a can generate an output that is communicated to the display processor 118b which in turn controls the display device 115 or other electronic devices associated with the display device 115 in accordance with the gesture. For example, the gesture processor 118a can generate an output that instructs the display processor 118b to scroll or turn a page displayed on the display device 115. Instructions based on the gesture algorithms can be encoded in the gesture processor 118a as software. In various implementations, the gesture algorithms can be based on the principles of neural networking and event driven processing to enable gesture recognition. A wide variety of gestures can be recognized or interpreted by the gesture processor 118a including but not limited to hand swipes, hand blocking, scrolling, finger flexing, finger counting, wrist roll, two hand gestures, moving the hand or fingers along a direction normal to the display surface, etc.

The size, density (or fill factor) of the plurality of light redirectors 203 is selected such that:
(i) a sufficient amount of ambient light incident on the light panel 101 is transmitted through the light panel 101 toward the display device 115. In various implementations, the amount of ambient light transmitted through the light panel 101 toward the display device 115 is such that the display device 115 is sufficiently bright.
(ii) a sufficient amount of the modulated light reflected from the display device 115 is transmitted out of the light panel light panel 101 such that image displayed by the display device 115 can be viewed with limited loss of brightness or contrast ratio. Additionally, the size and the geometry of the plurality of light redirectors can be such that the image can be viewed with little distortions, and
(iii) a sufficient amount of the light reflected from the display device 115 are redirected by the plurality of light redirectors toward the plurality of light detectors 509a and 509b and used for gesture recognition.

In various implementations, the plurality of light redirectors 203 can be arranged such that the density of the plurality of light redirectors 203 across the front surface 201a of the light guide 105 is uniform. In some implementations, the plurality of light redirectors 203 can be arranged such that the density of the plurality of light redirectors 203 across the front surface 201a of the light guide 105 varies. For example, in some implementations, the density of the plurality of light redirectors 203 can be higher in a central region of the light guide 105 and lower toward the edges of the light guide 105 as shown in FIG. 6C. Arranging the plurality of light redirectors 203 such that their density varies across the surface of the light guide 105 can be advantageous to efficiently convey light reflected from the display device 115 toward the light detectors 509a and 509b. In the implementation shown in FIG. 6C, for example, the light redirectors 203 are arranged in a manner that increases in their density farther from the light sources 109 and potentially in accordance with lower light levels farther from the light sources. In other implementations, the arrangement may be re-oriented by 90°. For example, the density of light redirectors 203 may increase farther from the light detectors 509 and potentially in accordance with longer distances to travel to reach the detectors after being deflected by the redirectors 203. The orientation of the individual light redirectors 203 may also be rotated, for example, by 90°.

FIG. 6C is a top view of an implementation of a light panel 101 configured to detect gestures. The illustrated implementation includes a light guide 105 having light redirectors 203, a plurality of light detectors 509a-509f disposed along a plurality of edges of the light guide 105 that are facing each other, and a plurality of light emitters 109a-109p disposed along the other edges of the light guide 105. The plurality of light emitters 109a-109p are optional and can be used to provide illumination to a display device 115 (not shown) that is positioned rearward of the light panel 101. For example, light from the plurality of light emitters 109a-109p that is coupled into and propagates through the light guide 105 can be redirected toward the display device 115 by the plurality of light redirectors 203 for the purpose of front illuminating the display device 115. The plurality of light redirectors 203 are configured such that light emitted from the plurality of light emitters 109a-109p is directed toward the display device 115 and ambient light reflected from one or more reflective surfaces of the display device 115 is either transmitted toward a viewer viewing the display device 115 through the light panel 101 or redirected by the light redirectors 203 toward the plurality of light detectors 509a-509f for gesture recognition. In this manner, the light guide 105 can be used for illumination purpose as well as for gesture recognition.

As discussed above, the density of the plurality of light redirectors 203 in the implementation illustrated in FIG. 6C varies across the surface of the light guide 105. The density of the plurality of light redirectors 203 is higher in the central portion of the light guide 105 and lower toward the edges of the light guide 105. The variable density of the plurality of light redirectors 203 can be advantageous in distributing light emitted from the plurality of light emitters 109a-109p uniformly across the entire display device 115. In the illustrated implementation, the density of the plurality of light redirectors 203 has a gradient that decreases outwardly along the y-direction from the central portion of the light guide 105. In various implementations, the density of the plurality of light redirectors 203 can have a gradient that varies outwardly along the x-direction from the central portion of the light guide 105. In various implementations, regions along the edges of the light guide 105 closer to the plurality of light detectors 509a-509f can be devoid of the plurality of light redirectors 203, such that those regions form a light pipe that can efficiently transport light to the plurality of light detectors 509a-509f.

FIG. 6D illustrates a flow chart 650 of an example method of using the implementations of the light panel 101 described herein for gesture recognition. As discussed above and as shown in block 652, a portion of ambient light that passes through a light guide (e.g. light guide 105) is reflected from a surface of a reflective display device (e.g. display device 115). The portion of the reflected ambient light is turned using a plurality of light turning features (e.g. light redirectors 203) included in the light guide 105, as indicated in block 654. The method of using the implementations of the light panel 101 described herein for gesture recognition further includes guiding the turned portion of the reflected ambient within the light guide (e.g. light guide 105) towards a plurality of light detectors (e.g. light detectors 509a and 509b) as shown in block 656. The method further includes analyzing one or more shadows cast on the display device (e.g. display device 115) based on electrical signals from the plurality of light detectors (e.g. light detectors 509a and 509b). In various implementations, analyzing one or more shadows cast on the display device can include determining the position, duration and the shape of the cast shadow. This can be accomplished by detecting a change in the electrical output of the various light detectors integrated with the light panel 101. The variation in the intensity of light across the display panel 101 that results from the cast shadow can be determined from the change in the electrical output of the various light detectors to determine a spatio-temporal characteristic of the shadow.

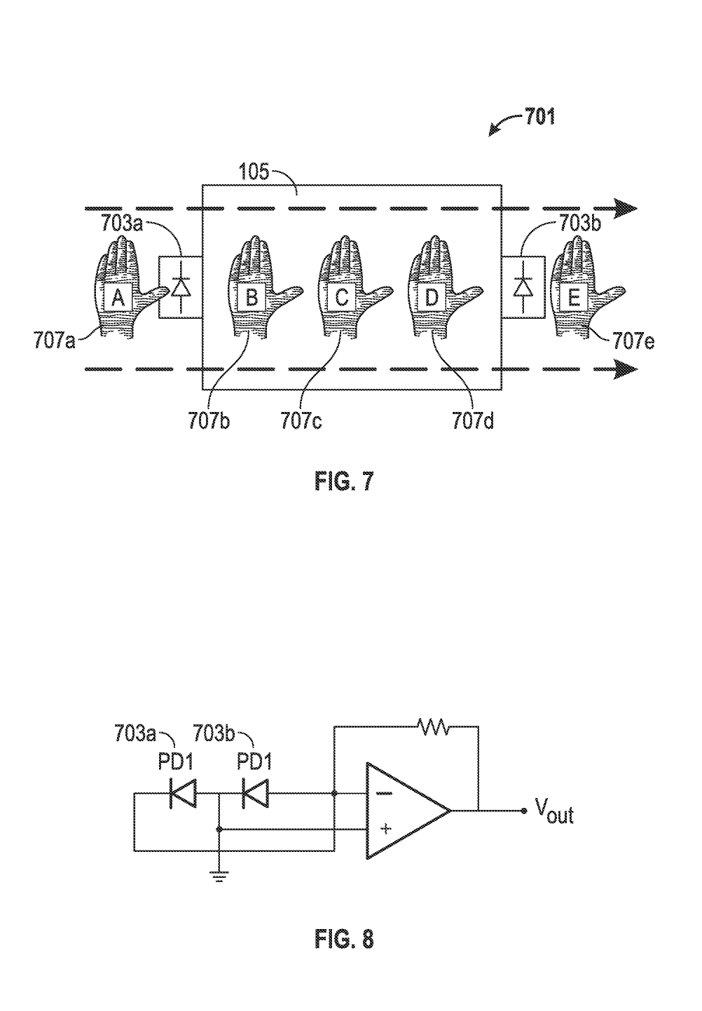

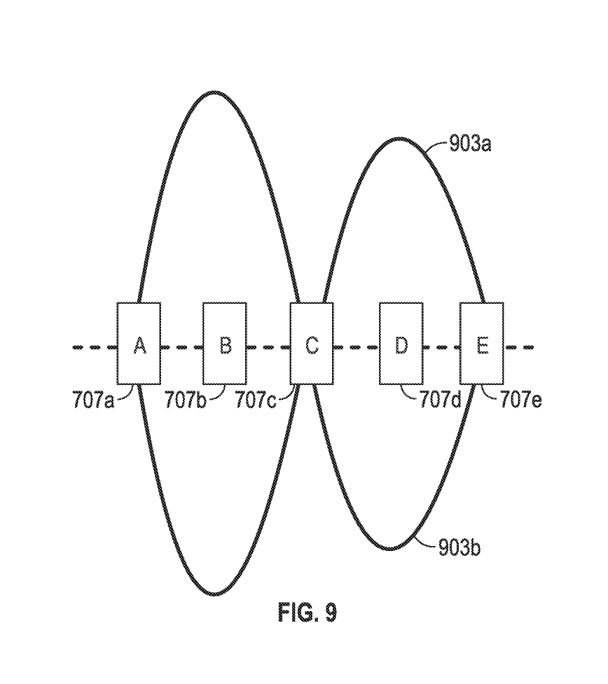

Turning now to FIG. 7, an embodiment of a light panel 701 is depicted. The light panel 701 is configured to detect light and includes a light guide 105 and two photodiodes 703a,b disposed along two opposite edges of the light guide 105. The light guide 105 may comprise light gathering features (not shown) configured to gather light received by the light guide 105 and turn the light such that the light propagates through the light panel 105 to the photodiodes 703a,b. For example, the light guide 105 may comprise acrylic with light gathering dots printed upon the piece of acrylic. The light gathering dots may comprise diffusive particles configured to scatter light and turn the light into the light guide 105. The photodiodes 703a,b may be electrically connected such that they may detect the motion, or location, of an object that is moved across the light guide 105. Such embodiments are further described in reference to FIGS. 8 and 9. For example, the photodiodes 703a,b may be connected to form a differential amplifier. In one embodiment, an object, for example, a hand, may move across the light guide 105 from left to right in five positions 707a, 707b, 707c, 707d, and 707e with each position changing the amount of light detected by each photodiode 703a,b.

Turning to FIG. 8, a diagram shows one example of an electrical connection between two photodiodes 703a,b illustrated in FIG. 7. The photodiodes 703a,b form a differential amplifier that outputs an electrical signal indicating the difference in light sensed by the two photodiodes 703a,b. The electrical signal output by the differential amplifier can be received by another device within a light panel and/or received by a device outside of the light panel. For example, the photodiodes may be electrically connected with a light source within a light panel and/or another electrical device housed outside of the light panel. In some embodiments, the photodiodes may be electrically connected with an output terminal configured to electrically connect a light panel with another device.

Turning now to FIG. 9, the output of the photodiodes 703a,b shown in FIG. 7 is shown as an object is moved from position 707a to 707e. Line 903a depicts the output of light sensed by photodiode 703a and line 903b depicts the output light sensed by photodiode 703b. When the object (e.g., the hand shown in FIG. 7) is in position 707a, the light panel 701 is unobstructed by the object. When the object is in position 707b, the object obstructs light near photodiode 703a and photodiode 707a detects less light than the other photodiode 703b. When the object is in position 707c, it is equidistant from both of the photodiodes 703a,b and each photodiode 703a,b detects the same amount of light. When the object is in position 707d, it is closer to photodiode 703b and photodiode 703b detects less light than the other photodiode 703a. Lastly, when the object is in position 707e, it does not obstruct the light panel 701 and each photodiode 703a,b detects the same amount of light. By connecting the photodiodes as shown in FIG. 8, the sequencing of positive and negative voltage pulses output by the photodiodes may indicate the direction of motion and can be used as a control mechanism. For example, an object moving from left to right over panel 101 may be used as a signal to turn a light emitting panel off or dim the panel. In another example, an object moving from right to left over a panel 101 may be used as a signal to turn a light emitting panel on or increase the amount of light emitted. In other embodiments, a constant obstruction over a particular part of the panel may trigger an event. For example, holding a hand over panel 101 in position 707a may turn something on or off. Additionally, the distance of an object, for example, a hand, from the panel 101 may further affect the outputs of the photodiodes 703a,b and be used as a control mechanism. The photodiodes 703a,b may be configured to detect various wavelengths of light. For example, in one embodiment the photodiodes 703a,b may be configured to detect visible light and in another embodiment the photodiodes may be configured to detect waves in the infra-red. In other embodiments, more photodiodes may be disposed along the light guide in order to increase the sensitivity of the light panel.

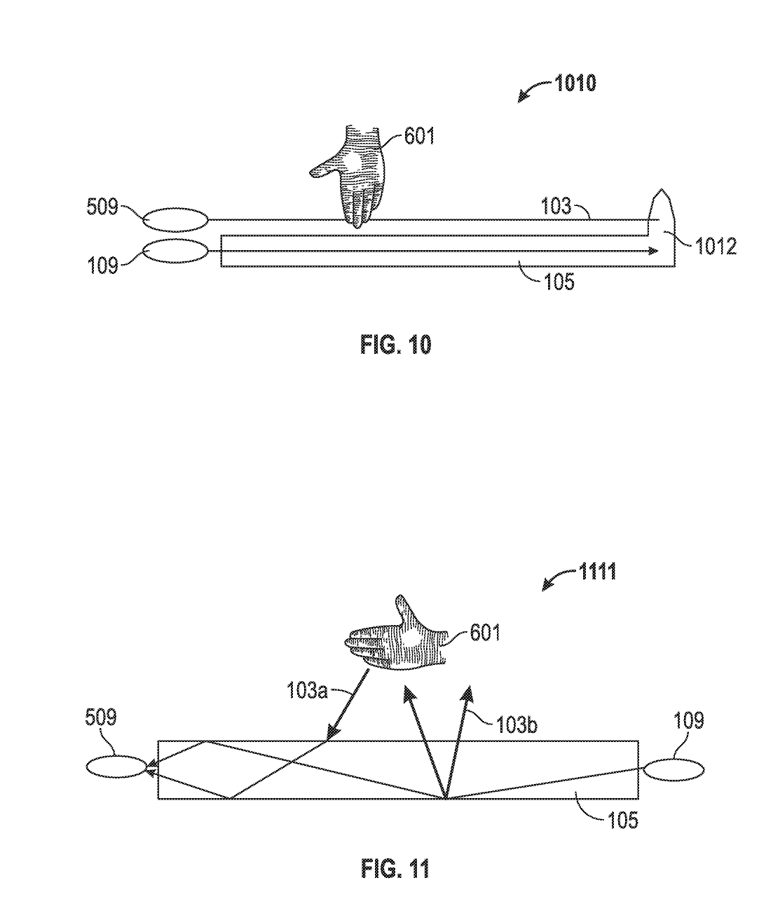

Turning now to FIG. 10, a light panel 1010 configured to emit and/or detect light is shown. The light emitting and light sensing panel 1010 includes a light guide 105. The light guide 105 may comprise optically transmissive material that is substantially optically transmissive to radiation at one or more wavelengths. A light source 109 is disposed along at least one edge of the light guide 105 and is configured to input light 103 into the light guide 105. The light 103 travelling within the light guide 105 may be trapped by total internal reflection until it reaches a turning feature 1012. Turning feature 1012 may be formed on the light guide 105 and may be configured to turn and direct light 103 out of the light guide 105 in one or more particular directions. The light panel 101 may also include a light detector 509 disposed along at least one edge of the light guide 105. The light detector 509 may be configured to detect light travelling in one or more directions towards the light detector. In one embodiment, the light detector 509 is configured to detect light 103 directed by turning feature 1012. The light detector 509 may be configured to act as a control mechanism to control something based on the amount of light detected. For example, the light detector 509 may be configured to act as a switch that turns a device off or on depending on whether light is detected. In one example, an object 601, for example, a hand, may be used to obstruct light 103 directed toward the light detector 509 by light turning feature 1012. When the object 601 obstructs the light directed to the light detector 509, the light detector 509 may detect less light and perform some control function.

Turning now to FIG. 11, a light panel 1111 configured to emit and/or detect light is shown. The light panel 1111 includes an optically transparent light guide 105. The light guide 105 may comprise optically transmissive material that is substantially optically transmissive to radiation at one or more wavelengths. A light source 109 is disposed along at least one edge of the light guide 105 and is configured to input light 103b into the light guide 105. A light detector (or sensor) 509 is also disposed along at least one edge of the light guide and is configured to detect light 103a that travels within the light guide 105 to the light detector 509. The light guide 105 may include a plurality of light turning features (not shown) and light gathering features (not shown). The light turning features may be configured to extract light 103b from within the light guide 105 and direct the light towards one or more particular directions. The light guide 105 may comprise light turning features on one or more sides and the light turning features may comprise any feature configured to turn or extract light, for example, refractive features, dots, grooves, pits, prismatic features, holograms, or diffractive gratings. The light guide 105 may also include one or more light gathering features (not shown) configured to receive light 103a incident on the light guide 105 and direct the light 105a through the light guide 105 toward the light detector 509. The light gathering features can turn the angle of incident rays of light 103a inside the light guide 105 such that the light can be bound within the light guide 105 by total internal reflection. In some embodiments, the light gathering features may be a microstructured thin film, volume or surface diffractive features, or holograms.

Still referring to FIG. 11, the light emitting and light sensing panel 1111 can be configured to simultaneously emit light from one or more sides of light guide 105 and detect light received by one or more sides of light guide 105. The light detector may be configured as a control mechanism to control the amount of light 103b emitted from the light source 109. For example, if the light detector 509 detects a threshold amount of ambient light, the light detector may turn the light source 109 off or dim the light source 109. In another example, if the light detector 509 does not detect a threshold amount of ambient light, the light detector 509 may increase the amount of light emitted by the light source 109. In another example, the light detector 509 may be configured to detect infra-red light and be configured as an occupancy sensor. In this example, the light detector 509 may turn the light source 109 on when infra-red light is detected and may turn the light source 109 off when infra-red light is not detected. As previously discussed with respect to FIGS. 7-9, a light sensing panel may be configured to detect a certain motion or location of an obstruction. The light emitting and light sensing panel 1111 depicted in FIG. 11 can also be configured to detect the location of a source of light gathered by the light guide 105 and/or to detect a certain motion of an object that comes between the light guide 105 and an external light source. In one embodiment, the light panel 1111 may be configured to emit light and detect ambient light or emitted light that is reflected back towards the light guide 105. For example, the light panel may be configured to emit a certain amount of light and the light detector may be configured to detect when an object 601 is placed near the light guide 105 based on the amount of emitted light that is reflected by the object 601 back towards the light guide 105. Additionally, in other embodiments, the light emitting and light sensing panel 1111 can detect light received on either side of the light guide 105 while simultaneously emitting light from one or both of these sides.

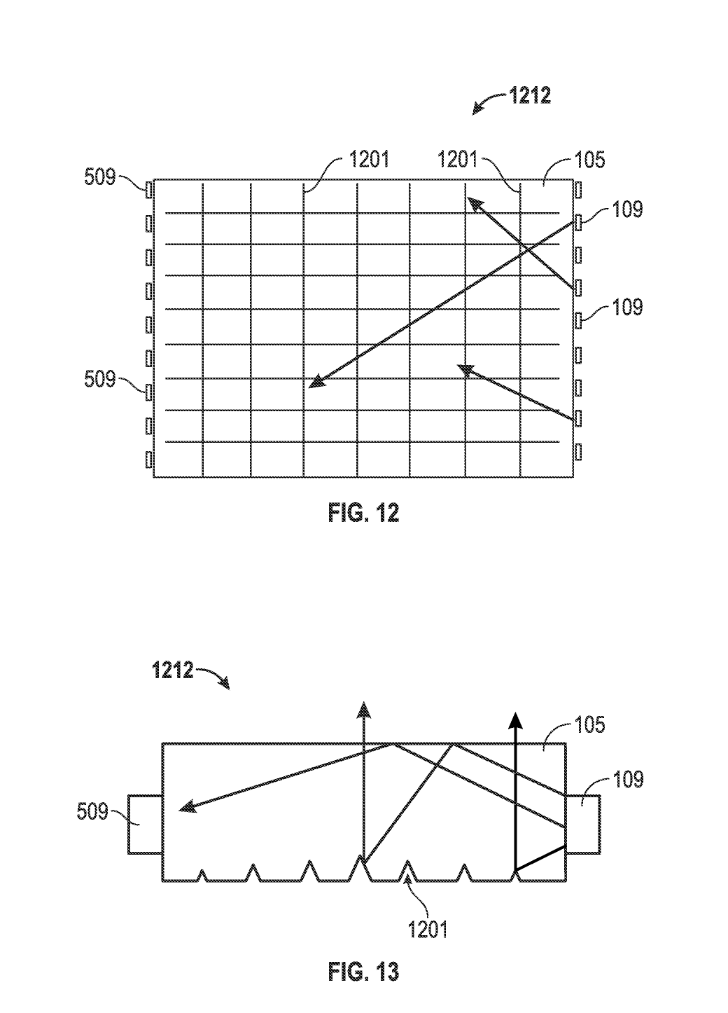

FIG. 12 illustrates a top schematic view of an embodiment of a light panel 1212 showing one type of light turning or gathering feature. In this example, the light panel 1212 may be configured to emit and/or gather light. The light panel 1212 includes features 1201. Features 1201 may be configured to extract light from within the light guide 105 or to gather light incident upon the light guide 105 and direct the light into the light guide 105. The features 1201 may be embossed or machines into light guide 105. The light sources 109 may comprise LEDs or any other suitable light source including linear light sources. Additionally, optional light detectors 509 may be disposed along one or more edges of the light guide 105. The light detectors 509 may be configured to detect the light that travels within the light guide 105 to the light detectors 509 and may be used to control the amount of light emitted by the light sources 109, among other things. For example, the light detectors 509 may be used to detect the amount of light that is incident on the light panel 1212 and trigger an event if the amount of light detected is more or less than certain threshold values. As shown in the embodiment of FIG. 13, light may propagate from the light sources 109 through the light guide 105 by total internal reflection until it encounters light a light turning feature 1212. When the light encounters light turning features 1212, some of the light may be extracted from the light guide 105 and be turned towards the front (or back) planar side making the light panel 1212 appear bright to a viewer. The light panel 1212 may also include light gathering features (not shown) configured to direct light incident on the light guide 105 towards the light detector 509.

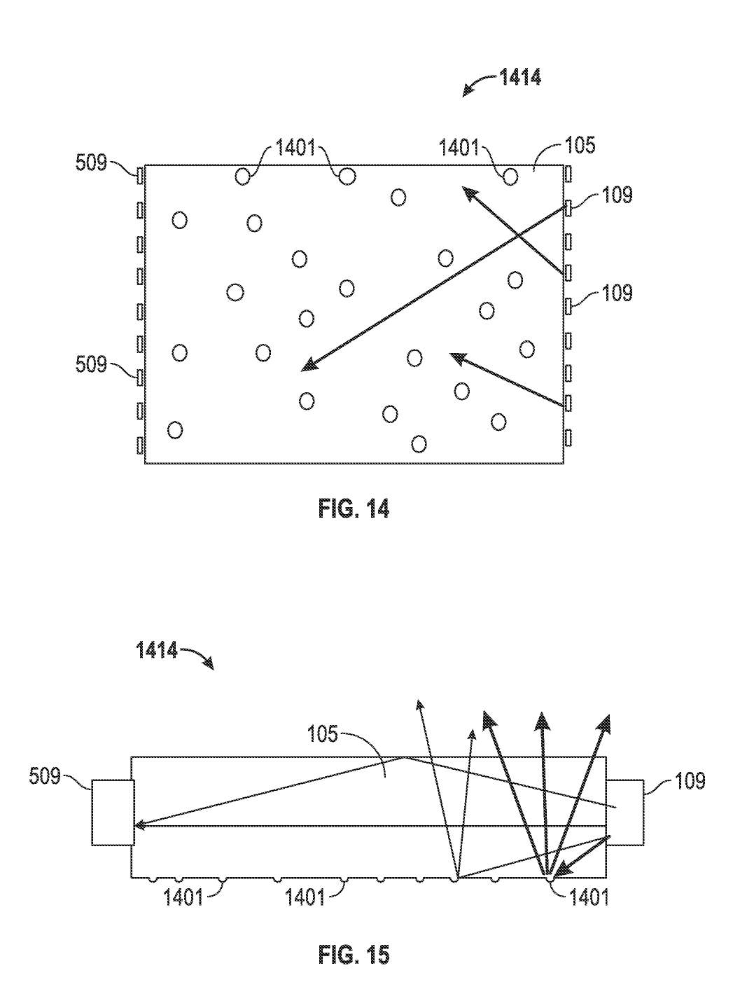

Turning now to FIG. 14, a light panel 1414 is depicted. In this example, the light panel 1414 may be configured to emit and/or gather light. The light panel 1414 includes printed light extraction dots. Dots 1401 may be printed upon the front, back, or both front and back surfaces of the light guide 105 to extract light input into the light guide 105 by light source 109 or to gather light incident on the light guide. Printed dots 1401 can be used to tailor the transparency and diffusion of the panel when in ambient light, un-illuminated by a light source 109. Additionally, dots 1401 can be used to create uniform or non-uniform light extraction, with light output on the front, back, or both sides of the light guide 105. When the light guide 105 is illuminated by light sources 109, the dots 1401 can be used to direct light toward a viewer. In some embodiments, the dots 1401 may comprise, for example, diffusive particles or opaque materials, and be configured thicker or with higher density to limit light transmission through the panel. In one embodiment, some dots 1401 may be configured to emit light input into the light guide 105 by the light sources 109 while other dots 1401 may be configured to gather light incident on the light guide 105 and direct the light through the light guide towards one or more light detectors 509. Thus, the light panel 1414 may be used as a light emitting and/or light sensing panel.

Turning now to FIG. 15, printed dots 1401 used as an alternative to machined/embossed features offer a low cost, flexible design (e.g., controllable efficiency and uniformity), and flexibility of light guide 105 material (e.g., dots can be used on many substrates including glass and plastic). Additionally, the dots 1401 can be simple to manufacture, may require a relatively low capital expenditure to manufacture, and are highly configurable. For example, the dots 1401 may be printed onto the light guide 105 by an ink jet printer, screen printing techniques, or any other ink printer. The dots may also be rolled, splattered, or sprayed onto the light guide 105.

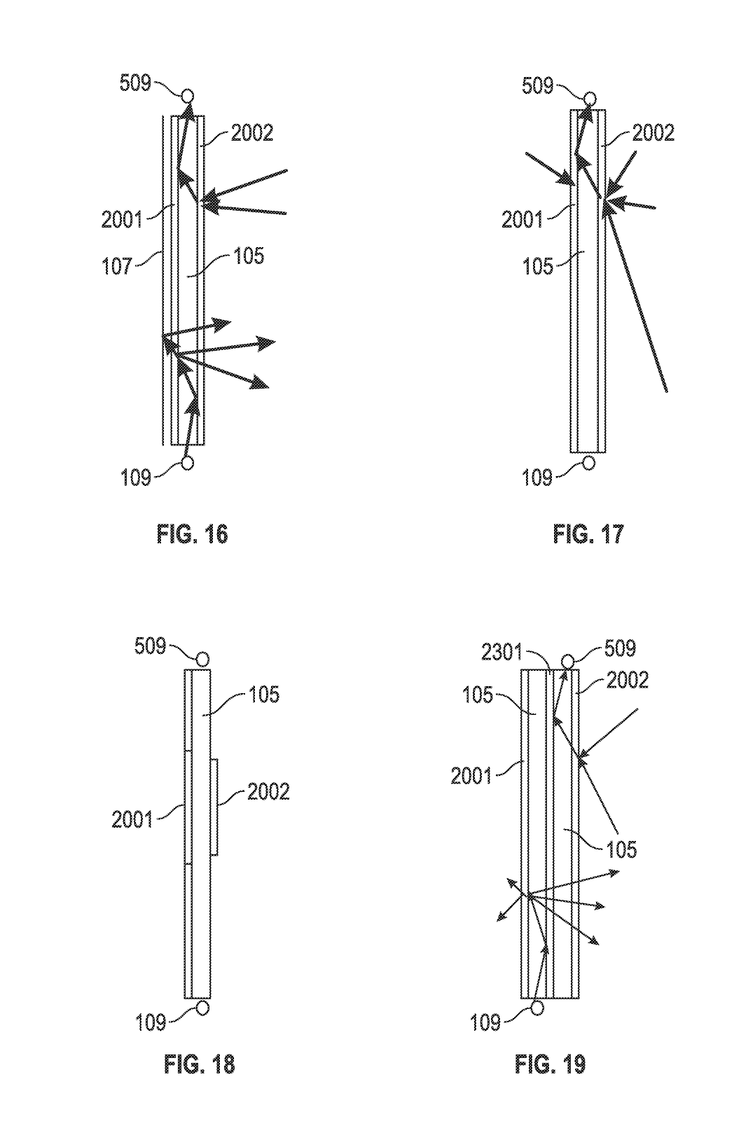

Turning now to FIG. 16, one embodiment of a large area light panel is depicted. Large area light panels can be optimized for the required lighting performance. For example, certain light extracting features can be selected to be disposed on either a front surface, a back surface, or both. Also, light sources of different wavelengths can be used. Such optimized configurations can also include light detectors having different sensitivities (e.g., to different light of wavelengths, or intensity). Light turning features may be used to extract light that was injected into the panel edges, out of the panel for illumination. The light turning features can naturally operate in a reciprocal mode to turn light incident on the panel into the panel where it can propagate by total internal reflection (TIR) toward sensors coupled to the light guide such that they receive a portion of the light propagating within the light guide, allowing the panel to operate as a dual mode device (emitter/sensor), or if a light source is omitted, as a sensor only. Some applications of a large area light panel may require the sensing performance to be optimized in a different way than the lighting functionality. For example, a panel may be configured to sense infra-red waves and emit visible light. In another example, a light panel may be configured as a broad, uniform light panel with infra-red occupancy sensing in one or more directions only. In another example, a light panel may be configured to provide uniform lighting while sensing may be limited to a small area of the panel, for example, for control purposes. In such examples, light detectors and sensors can be selected that are operable for different wavelengths (or frequencies) of light, such that the light emitting functionality has a minimal (or no) impact on the sensing functionality.

Still referring to FIG. 16, one embodiment of a large area light panel includes a light guide 105. Disposed along one or more edges of the light guide 105 may be one or more light detector (or sensor) 509 and one or more light source 109. The light gathering features may be configured to direct light incident on the light guide 105 into the light guide 105 and towards the light detector 509. The light gathering features 2002 may be optimized for light detecting or sensing. Also, light turning features 2001 may be disposed on more or more surface of the light guide 105. The light turning features may be configured to extract light that is input into the light guide 105 by the light source 109 from the light guide 109 towards one or more directions. The light turning features 2001 can comprise prismatic facets, printed dots, diffractive (e.g., holographic features), etc. The light turning features 2001 can have wavelength spectrum selectivity. For example, some infra-red light used for sensing may be scattered at the surface of the light guide 105, but at least some of the light will enter the light guide and propagate via TIR to the light detector 509. For improved detecting, in some embodiments, light turning features can be made less sensitive to the wavelengths used for sensing. In some embodiments, light gathering features 2002 are configured to not interact with visible light wavelengths and may be optimized for sensing particular wavelengths (e.g., infra-red). For example, a holographic film may be laminated to the panel. A holographic film may be customized to turn incident light into the panel, selecting only certain wavelengths or with specific directionality. In one example, a film could be bonded to the panel using a pressure sensitive adhesive of higher or equal index to the film. An optional substrate 107, for example a reflector, may be disposed near the light panel and configured to obstruct light emitted from the light panel or reflect light emitted from the light panel back towards the light guide 105.

Turning now to FIG. 17, the large area light panel depicted in FIG. 16 is shown without the optional reflector. Arrows show the relative sensitivity of film designed to turn light into the light guide 105 and toward the light detector (or sensor) 509 from one particular direction.

Turning now to FIG. 18, an embodiment of a light panel is depicted. The light panel includes a light guide 105. Light turning features 2001 can be disposed on a portion of a planar surface on one side to the light guide 105 (e.g., a small portion), and light gathering features 2002 can be disposed on a portion of the opposite planar surface of the light guide 105 (e.g., a small portion). The light turning features 2001 (behind the sensor film) can be modified to indicate where this area is by extracting a light having a certain color or brightness.

Turning now to FIG. 19, an embodiment of a light panel is shown. The light panel includes two light guides 105 separated by a low refractive index (N) layer 2301. Each light guide 105 may have a higher refractive index than the low refractive index layer 2301. A light source 109 may be disposed along one or more edges of one or both of the light guides 105 and a light detector 509 may be disposed along one or more edges of one or both of the light guides 105. Thus, a dual sided panel can be designed with features optimized for light emitting on one surface and light detecting on the other. Some interaction may occur between the light detecting and light emitting features of the light panel depicted in FIG. 16. However, it may be desirable to limit the interaction of the detecting and light emitting turning features, especially with simple techniques where reciprocal behavior is likely, for example, with printed dots.

The light guide material may comprise a substrate, for example, acrylic, glass, polyethylene terephthalate (PET), or PET-G. In one example, a large area light guide (such as 4×8′) may be approximately 0.25″ thick. Two such light guides could be bonded together with a lower refractive index isolation later between the two. In this example, light may propagate from TIR within each light guide 105 but light trapped in either light guide by TIR cannot cross into the other light guide 105. Light collected and gathered for detecting will be less subject to scattering by lighting turning features and vice versa. In one embodiment, a low index isolation layer 2301 is a low index adhesive. In other embodiment, light turning features 2001 and light gathering features 2002 do not cover identical areas (e.g., sensing panel where turning features could be limited to a small area, or areas, of a light guide 105). In one example, the materials of each light guide 105 and thicknesses could be different with each light guide 105 having a higher refractive index than the low index isolation layer 2301.

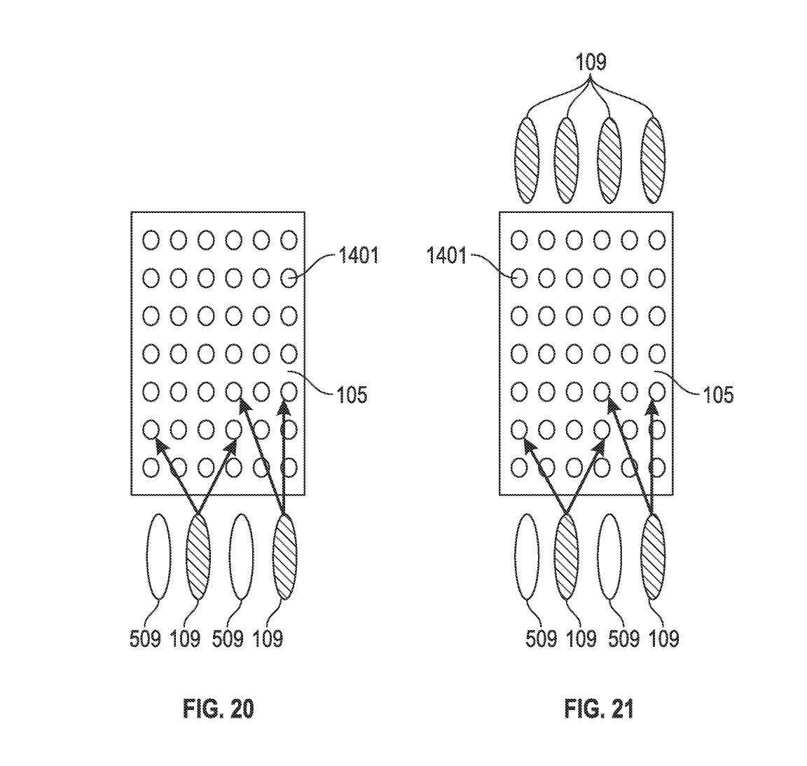

Turning now to FIG. 20, an embodiment of a light panel configured to emit and detect light is shown. The light panel includes a light guide 105 with printed ink dots 1401 printed on one or more surfaces of the light guide 105. Light sensors 109 and light detectors 509 may be disposed along one or more edges of the light guide 105. A light panel, for example, the light panel depicted in FIG. 20, can be used to sense the presence of or variations in ambient radiation (e.g., ambient visible light coming from natural or other illumination sources incident on the light guide 105). In one example, a light panel may be configured to sense natural solar or body heat infra-red waves, or variations in infra-red waves from other sources of heat in a room that may be caused by movement of objects or people (passive infra-red sensing). In another embodiment, a light panel may be designed to emit light in one set of wavelengths while detecting light in another set of wavelengths to avoid swamping the detectors 509 coupled to the same light guide 105 as the light sources 109. Visible or near infra-red wavelength detectors 509 may be made from silicon. Material commonly used in passive infra-red sensing include gallium nitride, caesium nitrate, polyvinyl fluorides, derivatives of phenylprazine, cobalt phthalocyanine, and lithium tantalite. In one example, the panel may be designed to sense light emitted by the panel and reflected back to the light guide. In one example, detectors 509 may be designed with sufficient dynamic range so they are not swamped by light directly coupled from the light sources 109. In another example, detectors 509 may be placed to minimize coupling, or light extraction features designed for minimum direct sensor illumination. The printed dots 1401 may be designed to avoid back scatter of illumination light directly back toward a detector 509. Prismatic features or other light turning features may also be used. The detectors 509 may be placed on the same edge(s) as the light sources 109 so the light cone of the light sources 109 does not directly illuminate the detectors 509.

Turning now to FIG. 21, an embodiment of a light panel configured to emit and detect light is shown. In some examples, ambient light sensing may be desired but detectors 509 may be potentially swamped by light source 109 output. This may be important where the sensing is being used to sense the room lighting state for automatic control of the light (e.g., sensing the onset of darkness).

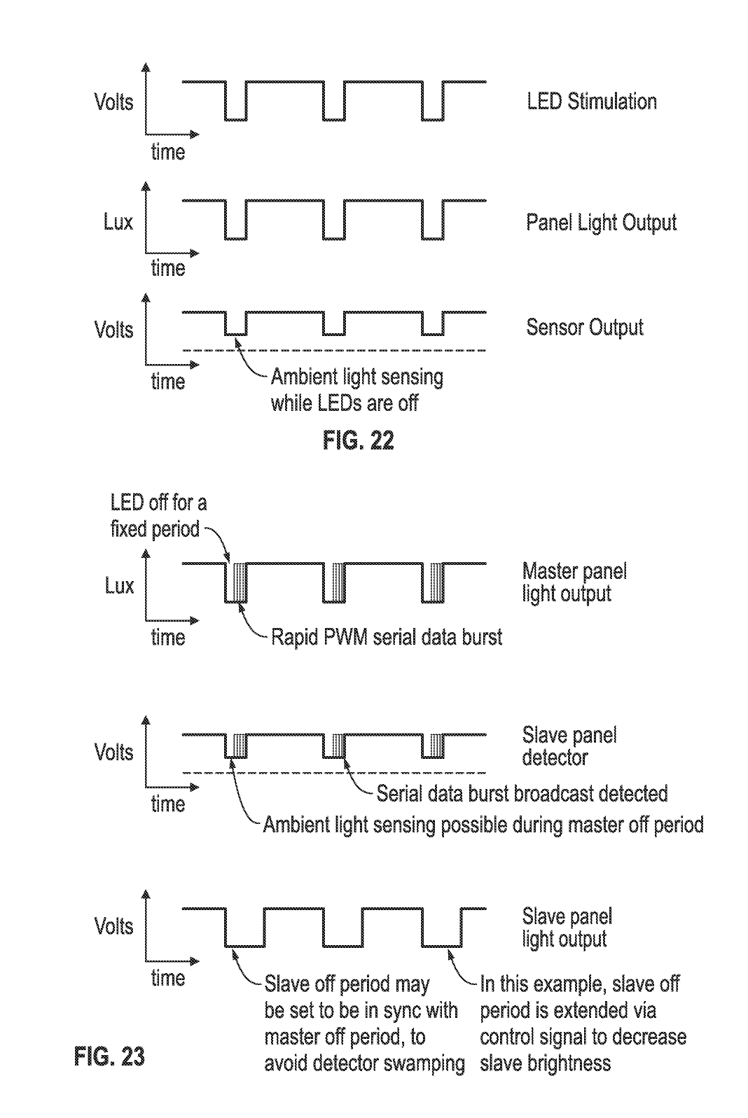

Turning now to FIG. 22, pulse width modulation (PWM) may be used to provide “breaks” in light output that can be used for sensing or detecting light (e.g., with LED light sources which have a steep electrical input to light output response curve). PWM can be used for LED light dimming where a high frequency pulsed light output is integrated by the eye to create the impression of a steady illumination level defined by the LED duty cycle. Pulse repetition rates of greater than approximately 60 Hz or breaks in illumination of about less than 20 ms may not be detectable by the human eye.

Turning now to FIG. 23, PWM of LED light sources can be used for light dimming, or to provide breaks in light output for ambient light sensing. The same system can be used for the remote control of light panels. The light output of one panel can be PW or amplitude modulated at high frequency (10s to 1000s of Hz) which is undetectable by the eye, but detectable by a detector in a light panel to carry control information. Some advantages are daisy chaining of light control without the need for dedicated control circuits, common light source for lighting and remote control is possible (though not essential), and reuse of control sensor for remote control.

In one example, in a room, one panel may be designated as a master and the others as slaves, set to receive some form of serial data from the master, which could be used to set, for example, on/off state, brightness, and color. With an appropriate code, slave devices (“slaves”) could also be addressable as groups or individually. In the master/slave control example depicted in FIG. 23, the master can include a periodic PWM data burst in LED output. In one mode, the slave synchronizes an LED off period with the data burst to allow for data (and ambient) sensing. Initial slave signal acquisition is possible by known techniques including: 1) start master first, slaves LEDs initially in off state, until data detected; 2) slave unsynchronized periodic LED off period repetition rate is set to be higher than synchronized rate, so slave will eventually detect and sync to master data bursts. In other examples, asynchronous slave operation is also possible by providing regular slave LED off/sensing periods where the sensor can listen for a random data burst.

An example of an electromechanical systems device, to which the above described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

FIG. 24 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 24 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 24, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (A).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 25 shows an example of a system block diagram illustrating an electronic device incorporating a 3×3 interferometric modulator display. The electronic device includes a processor 21 that may be configured to execute one or more software modules. In various implementations, the processor 21 can be similar to the display processor 118b described above with reference to FIG. 6B. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 25. Although FIG. 25 illustrates a 3×3 array of IMODs for the sake of clarity, the display array 30 may contain a very large number of IMODs, and may have a different number of IMODs in rows than in columns, and vice versa.

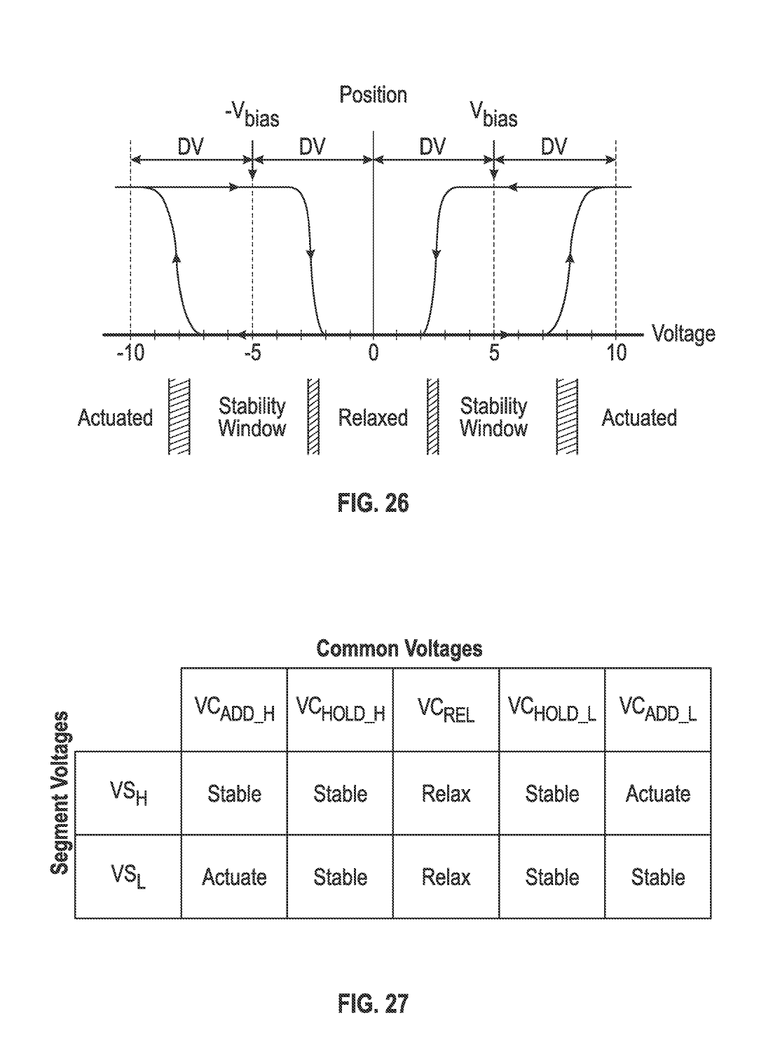

FIG. 26 shows an example of a diagram illustrating movable reflective layer position versus applied voltage for the interferometric modulator of FIG. 24. For MEMS interferometric modulators, the row/column (i.e., common/segment) write procedure may take advantage of a hysteresis property of these devices as illustrated in FIG. 26. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state.

This is referred to herein as the “hysteresis window” or “stability window.” For a display array 30 having the hysteresis characteristics of FIG. 26, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 24, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

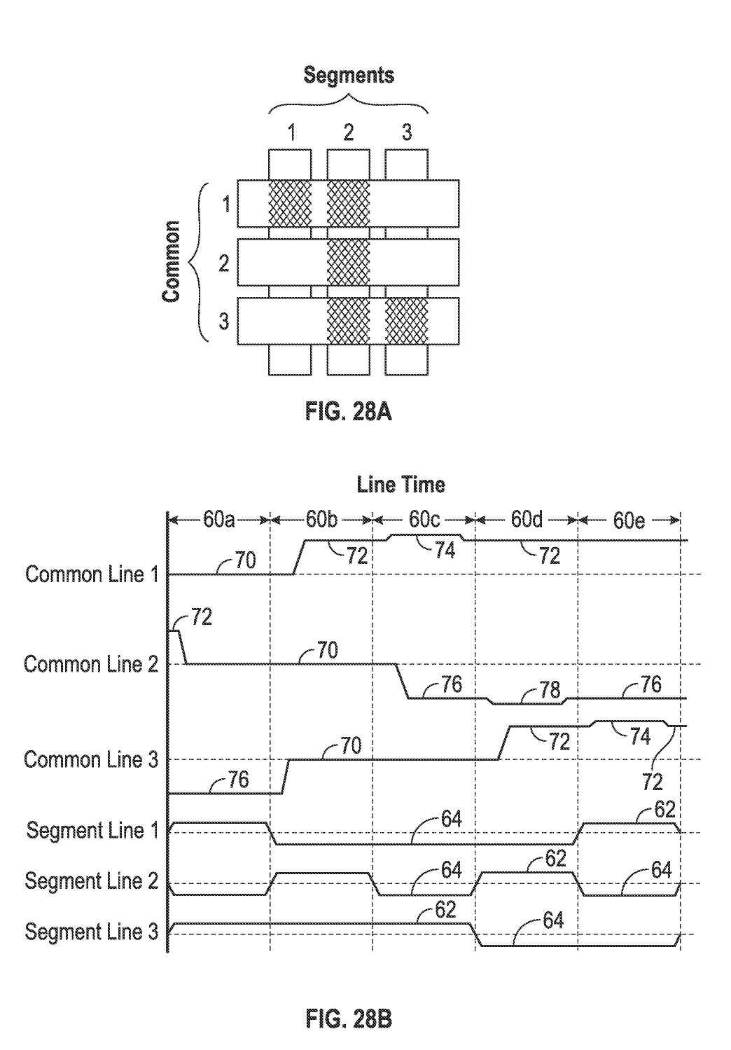

As illustrated in FIG. 27 (as well as in the timing diagram shown in FIG. 28B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 28A shows an example of a diagram illustrating a frame of display data in the 3×3 interferometric modulator display of FIG. 25. FIG. 28B shows an example of a timing diagram for common and segment signals that may be used to write the frame of display data illustrated in FIG. 28A. The signals can be applied to the, e.g., 3×3 array of FIG. 25, which will ultimately result in the line time 60e display arrangement illustrated in FIG. 28A. The actuated modulators in FIG. 28A are in a dark-state, i.e., where a substantial portion of the reflected light is outside of the visible spectrum so as to result in a dark appearance to, e.g., a viewer. Prior to writing the frame illustrated in FIG. 28A, the pixels can be in any state, but the write procedure illustrated in the timing diagram of FIG. 28B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 27, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 28A, and will remain in that state as long as the hold voltages are applied along the common lines, regardless of variations in the segment voltage which may occur when modulators along other common lines (not shown) are being addressed.

In the timing diagram of FIG. 28B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 28B. In some other implementations, voltages applied along common lines or segment lines may vary to account for variations in the actuation and release voltages of different modulators, such as modulators of different colors.

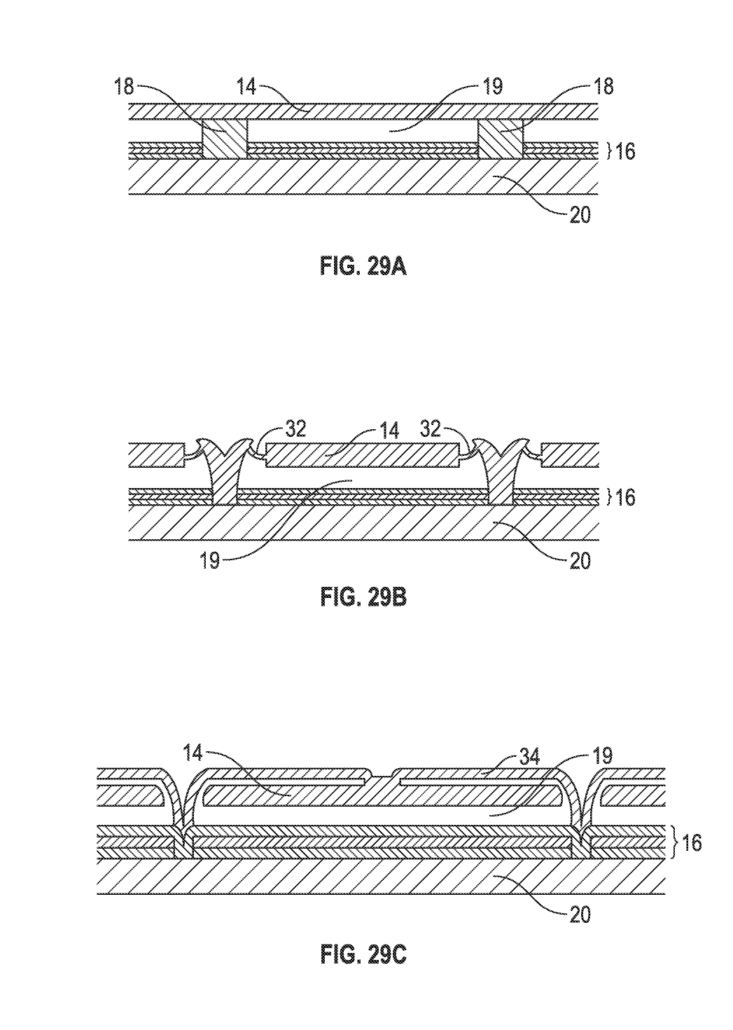

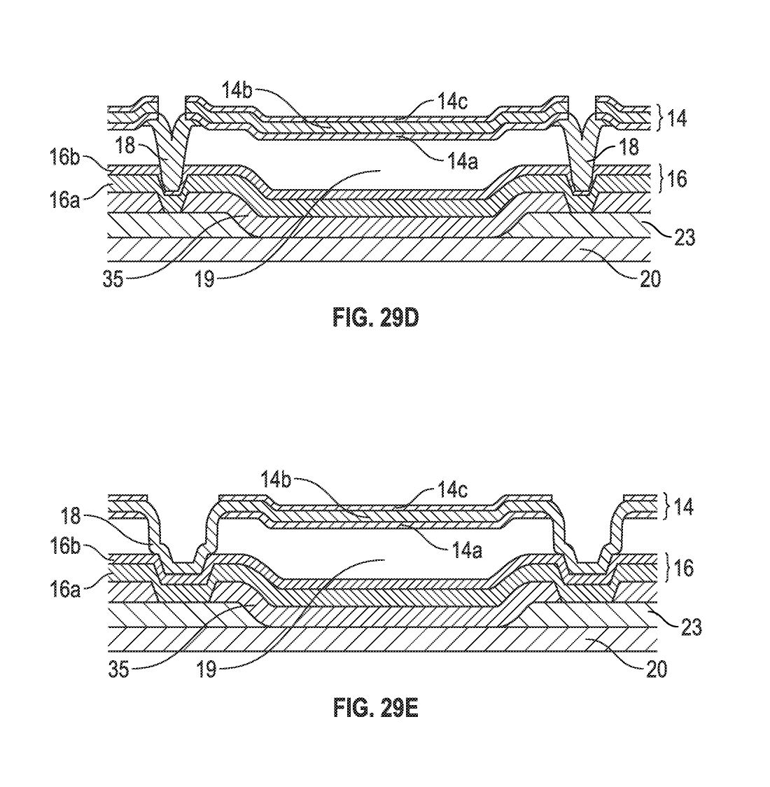

The details of the structure of interferometric modulators that operate in accordance with the principles set forth above may vary widely. For example, FIGS. 29A-29E show examples of cross-sections of varying implementations of interferometric modulators, including the movable reflective layer 14 and its supporting structures. FIG. 29A shows an example of a partial cross-section of the interferometric modulator display of FIG. 1, where a strip of metal material, i.e., the movable reflective layer 14 is deposited on supports 18 extending orthogonally from the substrate 20. In FIG. 29B, the movable reflective layer 14 of each IMOD is generally square or rectangular in shape and attached to supports at or near the corners, on tethers 32. In FIG. 29C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 29C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 29D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 29D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 29E shows another example of an IMOD, where the movable reflective layer 14 is self supporting. In contrast with FIG. 29D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 29A-29E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

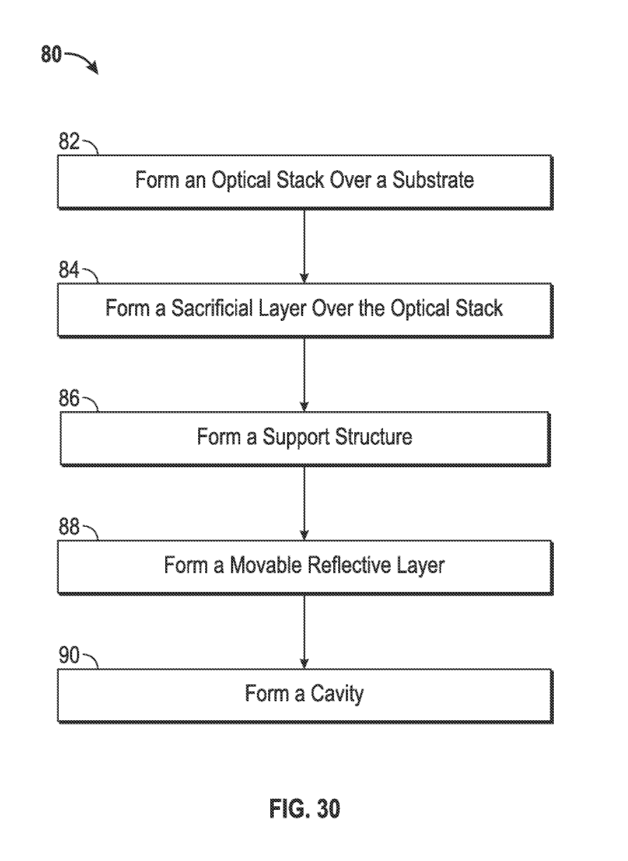

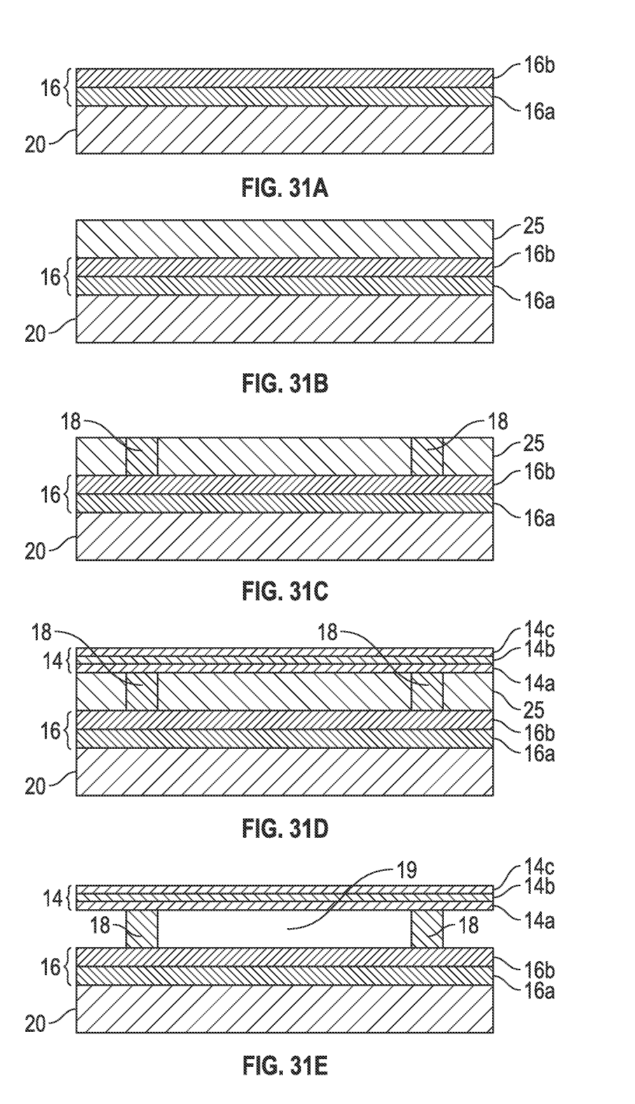

FIG. 30 shows an example of a flow diagram illustrating a manufacturing process 80 for an interferometric modulator, and FIGS. 31A-31E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 30. With reference to FIGS. 24, 29 and 30, the process 80 begins at block 82 with the formation of the optical stack 16 over the substrate 20. FIG. 31A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 31A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 24. FIG. 31B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 24 and 31E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 24, 29 and 31C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 29A. Alternatively, as depicted in FIG. 31C, the aperture formed in the sacrificial layer 25 can extend through the sacrificial layer 25, but not through the optical stack 16. For example, FIG. 31E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 31C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 24, 29 and 31D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 31D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 24, the movable reflective layer 14 can be patterned into individual and parallel strips that form the columns of the display.

The process 80 continues at block 90 with the formation of a cavity, e.g., cavity 19 as illustrated in FIGS. 24, 29 and 31E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

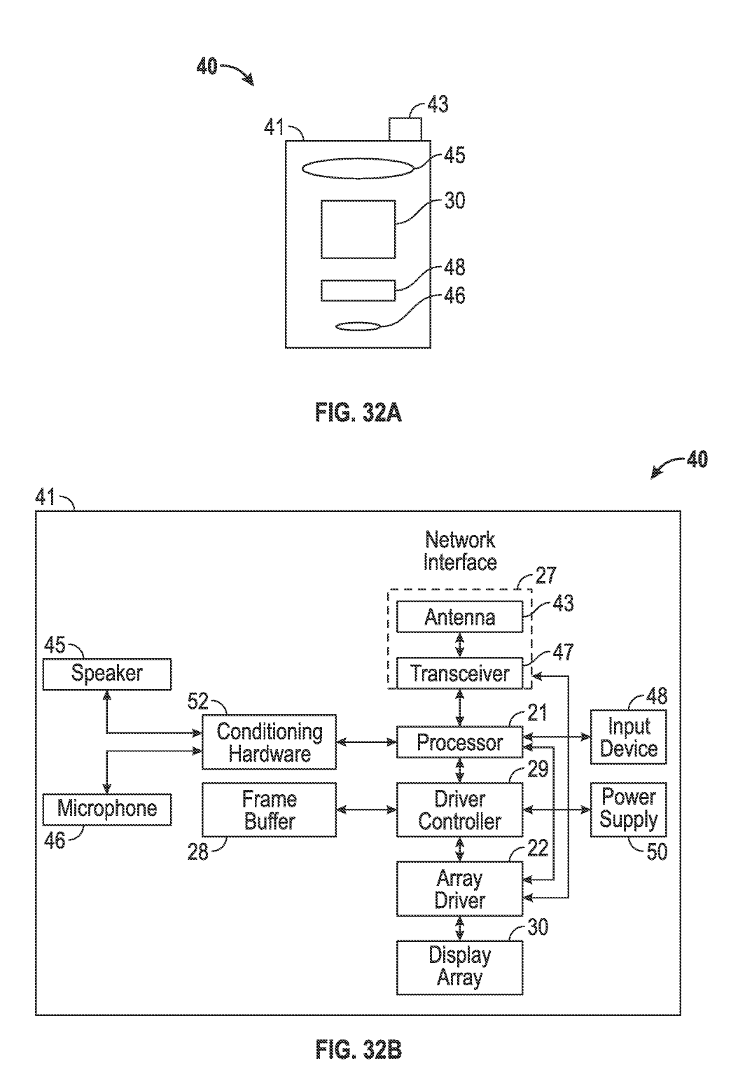

FIGS. 32A and 32B show examples of system block diagrams illustrating a display device 40 that includes a plurality of interferometric modulators. In various implementations, the display device 40 can be similar to the display device 115 described above with reference to FIG. 6B. The display device 40 or can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 32B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

The gesture recognition algorithm that is implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A device for receiving optical input, the device comprising:
a reflective display;
a light guide forward of the reflective display such that ambient light passes through the light guide to the reflective display, the light guide including a plurality of turning features configured to receive a portion of the ambient light reflected from the reflective display and turn the portion of reflected light such that it is guided within the light guide;
a plurality of light detectors disposed to receive the reflected light guided within the light guide; and
a processor configured to analyze one or more shadows cast on the device based on electrical signals from the plurality of light detectors.

2. The device of claim 1, wherein the reflective display includes a plurality of interferometric modulators.

3. The device of claim 1, wherein the reflective display includes at least one electromechanical systems device.

4. The device of claim 1, wherein the reflective display includes at least one device having a movable actuator that modulates light.

5. The device of claim 1, wherein the light guide has a forward surface configured to receive ambient light, a rearward surface configured to transmit the received ambient light toward the reflective display and a plurality of edges enclosed between the forward and rearward surfaces, and wherein the plurality of optical sensors are disposed along one or more of the plurality of edges.

6. The device of claim 5, wherein the one or more shadows cast are produced by hand gestures within less than about 4 inches from the forward surface of the light guide.

7. The device of claim 5, wherein the plurality of turning features is disposed on the forward surface of the light guide.

8. The device of claim 1, further comprising a light source disposed along one or more of the plurality of edges.

9. The device of claim 8, wherein the light source includes a plurality of light emitting diodes.

10. The device of claim 1, wherein the plurality of turning features include at least one of: prismatic elements, reflective elements, scattering elements and diffractive elements.

11. The device of claim 1, wherein a density of the plurality of turning features is lesser near the plurality of edges of the light guide than a density of the plurality of turning features in a central portion of the light guide.

12. The device of claim 1, wherein the plurality of light detectors include at least one photodiode

13. The device of claim 1, wherein between 20%-60% of the ambient light is reflected by the device without being modulated.

14. The device of claim 1, further comprising a memory device that is configured to communicate with the processor.

15. The device of claim 1, further comprising a driver circuit configured to send at least one signal to the reflective display.

16. The device of claim 15, further comprising a controller configured to send at least a portion of the image data to the driver circuit.

17. The device of claim 1, further comprising an image source module configured to send the image data to the processor.

18. The device of claim 17, wherein the image source module includes at least one of a receiver, transceiver, and transmitter.

19. The device of claim 1, further comprising an input device configured to receive input data and to communicate the input data to the processor.

20. A device for receiving optical input, the device comprising:
a reflective display;
a means for guiding light, the light guiding means disposed forward of the reflective display such that ambient light passes through the light guiding means to the reflective display, the light guiding means including a plurality of means for turning light configured to receive a portion of the ambient light reflected from the reflective display and turn the portion of reflected light such that it is guided within the light guiding means;
a plurality of means for detecting light disposed to receive the reflected light guided within the light guiding means; and
means for analyzing one or more shadows cast on the device based on electrical signals from the plurality of light detecting means.

21. The device of claim 20, wherein the light guiding means includes a light guide, or the light turning means includes light turning features, or the light detecting means includes photodiodes, or the analyzing means includes a processor.

22. The device of claim 20, wherein the one or more shadows cast are produced by hand gestures within less than about 4 inches from a forward surface of the light guiding means.

23. The device of claim 20, wherein the reflective display includes at least one display element having a movable actuator that modulates light.

24. A method of optically recognizing gestures, the method comprising:
reflecting a portion of ambient light that passes through a light guide from a surface of a reflective display on a device for receiving optical input, the light guide disposed forward of the reflective display;
turning the portion of reflected ambient light using a plurality of light turning features included in the light guide such that the portion of reflected ambient light is guided within the light guide towards a plurality of light detectors;
analyzing one or more shadows cast on the device based on electrical signals from the plurality of light detectors.

25. The method of claim 24, wherein the one or more shadows cast are produced by hand gestures within less than about 4 inches from a forward surface of the light guide.
